(19) United States
(12) Patent Application Publication
(10) Pub. No.: US 2026/0188243 A1
(43) Pub. Date: Jul. 2, 2026

(54) GATE DRIVER, DISPLAY DEVICE INCLUDING THE GATE DRIVER AND ELECTRONIC DEVICE INCLUDING THE GATE DRIVER

(71) Applicant: Samsung Display Co., Ltd., Yongin-Si (KR)

(72) Inventors: KYUNGHO KIM, Yongin-si (KR); HYEONGSEOK KIM, Yongin-si (KR); BYUNGCHANG YU, Yongin-si (KR)

(21) Appl. No.: 19/309,617

(22) Filed: Aug. 26, 2025

(30) Foreign Application Priority Data
Dec. 26, 2024 (KR) 10-2024-0196763

(51) Int. Cl. G09G 3/3266; G09G 3/32; G09G 3/36

(52) U.S. Cl. CPC G09G 3/3266; G09G 3/32; G09G 3/3677; G09G 2310/0267; G09G 2310/0281; G09G 2310/08; G09G 2330/021

(57) ABSTRACT

A gate driver may include a control signal generating block configured to generate a first common control signal and generate a second common control signal, an output control signal generating block configured to generate an output control signal, a first gate signal output control block configured to generate a first output control voltage based on the output control signal, the first carry signal and the second carry signal, a first gate signal control block configured to output first gate signals and the boosting control signal, a second gate signal output control block configured to generate a second output control voltage and a second gate signal control block configured to output second gate signals.

### PRIORITY STATEMENT

This application claims priority under 35 U.S.C. § 119 to Korean Patent Application No. 10-2024-0196763, filed on Dec. 26, 2024 in the Korean Intellectual Property Office KIPO, the contents of which are herein incorporated by reference in their entireties.

### BACKGROUND

### 1. Field

Embodiments of the present inventive concept relate to a gate driver, a display device including the gate driver and an electronic device including the gate driver. More particularly, embodiments of the present inventive concept relate to a gate driver reducing a power consumption, a display device including the gate driver and an electronic device including the gate driver.

### 2. Description of the Related Art

Generally, a display device includes a display panel and a display panel driver. The display panel includes a plurality of gate lines, a plurality of data lines and a plurality of pixels. The display panel driver includes a gate driver providing a gate signal to the gate lines, a data driver providing a data voltage to the data lines and a driving controller controlling the gate driver and the data driver.

A sensing operation may be performed for generating sensing data of the pixel.

### SUMMARY

Embodiments of the present inventive concept provide a gate driver for performing sensing operation.

Embodiments of the present inventive concept also provide a display device including the gate driver.

Embodiments of the present inventive concept also provide an electronic device including the gate driver.

According to embodiments, a gate driver may include a control signal generating block configured to generate a first common control signal based on a first carry signal and a second carry signal and generate a second common control signal based on a third carry signal and a fourth carry signal, an output control signal generating block configured to generate an output control signal based on a first input signal, a second input signal and a boosting control signal, a first gate signal output control block configured to generate a first output control voltage based on the output control signal, the first carry signal and the second carry signal, a first gate signal control block configured to output first gate signals and the boosting control signal based on the first common control signal, the first output control voltage, a boosting clock signal and first clock signals, a second gate signal output control block configured to generate a second output control voltage based on the output control signal, the third carry signal and the fourth carry signal and a second gate signal control block configured to output second gate signals based on the second common control signal, the second output control voltage, the boosting clock signal and second clock signals.

In an embodiment, the output control signal generating block may include a first output control transistor including a control electrode receiving the first input signal, a first electrode receiving the boosting control signal and a second electrode connected to a first output control node, a second output control transistor including a control electrode receiving the first input signal, a first electrode connected to the first output control node and a second electrode connected to a second output control node, a third output control transistor including a control electrode connected to the second output control node and a second electrode connected to the first output control node, a fourth output control transistor including a control electrode receiving the second input signal, a first electrode connected to the first output control node and a second electrode connected to a first common control node and an output control capacitor including a first electrode receiving a first high voltage and a second electrode connected to the second output control node.

In an embodiment, when the first input signal has an activation level, and the boosting clock signal has a clock high level, the output control signal generating block may store the output control signal.

In an embodiment, when the second input signal has an activation level, the output control signal generating block may output the output control signal.

In an embodiment, the first gate signal control block may further output a carry signal based on a carry clock signal. When the first input signal has an activation level, the carry clock signal may have a clock high level.

In an embodiment, a frame period in which the gate driver is driven may include an active period in which the first gate signals are output and a blank period following the active period. In the blank period, a first gate signal of the first gate signals may have an activation level. In the blank period, a second gate signal of the second gate signals may have an activation level.

In an embodiment, in the blank period, the first output control voltage may have a first high voltage, and a first clock signal corresponding to the first gate signal may toggle between a clock high level and a clock low level.

In an embodiment, in the blank period, other first gate signals of the first gate signals may have an inactivation level. In the blank period, other second gate signals of the second gate signals may have an inactivation level.

In an embodiment, the first output control voltage may have a first high voltage or second high voltage lower than the first high voltage. The second output control voltage may have the first high voltage or the second high voltage. When the first output control voltage has the first high voltage, the first gate signals may be output. When the second output control voltage has the first high voltage, the second gate signals may be output.

In an embodiment, the first gate signals may include a first scan gate signal and a second scan gate signal. A frame period in which the gate driver is driven may include an active period in which first gate signals are output and a blank period following the active period. A period in which the first scan gate signal has an activation level may be consistent with a period in which the second scan gate signal has an activation level.

In an embodiment, the first output control voltage may have a first high voltage or second high voltage lower than the first high voltage. The second output control voltage may have the first high voltage or the second high voltage. When the first output control voltage has the first high voltage, the first gate signals may be output. When the second output control voltage has the first high voltage, the second gate signals may be output. In the first frame period, the second gate signals having activation levels may be output.

In an embodiment, the first gate signals may include a first scan gate signal and a second scan gate signal. A period in which the first scan gate signal has an activation level may be consistent with a period in which the second scan gate signal has an activation level.

In an embodiment, the first output control voltage may have a first high voltage or second high voltage lower than the first high voltage. The second output control voltage may have the first high voltage or the second high voltage. When the first output control voltage has the first high voltage, the first gate signals may be output. When the second output control voltage has the first high voltage, the second gate signals may be output. The first gate signal output control block may include a first output transistor including a control electrode receiving the first carry signal, a first electrode receiving the first high voltage and a second electrode connected to a first output voltage node, a second output transistor including a control electrode receiving the boosting control signal, a first electrode receiving the second high voltage and a second electrode connected to the first output voltage node, a third output transistor including a control electrode receiving the second carry signal, a first electrode receiving the second high voltage and a second electrode connected to the first output voltage node, a fourth output transistor including a control electrode receiving the second input signal, a first electrode receiving the output control signal and a second electrode connected to the first output voltage node. The second gate signal output control block may include a fifth output transistor including a control electrode receiving the third carry signal, a first electrode receiving the first high voltage and a second electrode connected to a second output voltage node, a sixth output transistor including a control electrode receiving the boosting control signal, a first electrode receiving the second high voltage and a second electrode connected to the second output voltage node, a seventh output transistor including a control electrode receiving the fourth carry signal, a first electrode receiving the second high voltage and a second electrode connected to the second output voltage node, an eighth output transistor including a control electrode receiving the second input signal, a first electrode receiving the output control signal and a second electrode connected to the second output voltage node.

In an embodiment, the second gate signal control block may include a first transistor including a control electrode connected to a first control line, a first electrode receiving the boosting clock signal and a second electrode connected to a first control node, a second transistor including a control electrode connected to a second control line, a first electrode connected to the first control node and a second electrode receiving a first low voltage, a third transistor including a control electrode connected to the first control line, a first electrode receiving a carry clock signal and a second electrode connected to a carry output node, a fourth transistor including a control electrode connected to the second control line, a first electrode connected to the carry output node and a second electrode receiving the first low voltage, a fifth transistor including a control electrode connected to a first node, a first electrode receiving a first clock signal and a second electrode connected to a second node, a sixth transistor including a control electrode receiving the second output control voltage, a first electrode connected to the first control line and a second electrode connected to the first node, a seventh transistor including a control electrode connected to the second control line, a first electrode connected to the second node and a second electrode receiving a second low voltage and a capacitor including a first electrode connected to the first node and a second electrode connected to the first control node.

According to embodiments, a display device may include a display panel including a plurality of pixels, a gate driver configured to output gate signals to the pixels, a data driver configured to apply data voltage to the pixels and a driving controller configured to control the gate driver and the data driver. The gate driver may include a plurality of stages. At least one stage of the stages may include a control signal generating block configured to generate a first common control signal based on a first carry signal and a second carry signal and generate a second common control signal based on a third carry signal and a fourth carry signal, an output control signal generating block configured to generate an output control signal based on a first input signal, a second input signal and a boosting control signal, a first gate signal output control block configured to generate a first output control voltage based on the output control signal, the first carry signal and the second carry signal, a first gate signal control block configured to output first gate signals and the boosting control signal based on the first common control signal, the first output control voltage, a boosting clock signal and first clock signals, a second gate signal output control block configured to generate a second output control voltage based on the output control signal, the third carry signal and the fourth carry signal and a second gate signal control block configured to output second gate signals based on the second common control signal, the second output control voltage, the boosting clock signal and second clock signals.

In an embodiment, the output control signal generating block may include a first output control transistor including a control electrode receiving the first input signal, a first electrode receiving the boosting control signal and a second electrode connected to a first output control node, a second output control transistor including a control electrode receiving the first input signal, a first electrode connected to the first output control node and a second electrode connected to a second output control node, a third output control transistor including a control electrode connected to the second output control node and a second electrode connected to the first output control node, a fourth output control transistor including a control electrode receiving the second input signal, a first electrode connected to the first output control node and a second electrode connected to a first common control node and an output control capacitor including a first electrode receiving a first high voltage and a second electrode connected to the second output control node.

In an embodiment, the gate driver may include a first stage and a second stage. The first gate signals may include first, second, third, and fourth scan gate signals and first, second, third, and fourth sensing gate signals. The first stage may output the first scan gate signal, the second scan gate signal, the first sensing gate signal and the second sensing gate signal. The second stage may output the third scan gate signal, the fourth scan gate signal, the third sensing gate signal and the fourth sensing gate signal

In an embodiment, in the blank period, the scan gate signal applied to the at least one pixel may have an activation level.

In an embodiment, the display device may further include a sensing driver configured to perform a sensing operation on at least one pixel of the pixels. A frame period in which the pixels are driven may include an active period in which the data voltage is applied and a blank period in which the sensing operation is performed on the at least one pixel. When the at least one pixel is connected to the first stage, the first output control voltage of the first stage and the second output control voltage of the first stage may have a first high voltage in the blank period. In the blank period, the scan gate signal applied to the at least one pixel has an activation level, and the sensing gate signal applied to the at least one pixel may have an activation level.

In an embodiment, the display device may further include a sensing driver connected to the pixels through sensing lines. At least one pixel of the pixels may include a driving transistor including a control electrode connected to a first node, a first electrode receiving a first power voltage and a second electrode connected to a second node, a scan transistor configured to apply the data voltage to the first node in response to a scan gate signal, a sensing transistor configured to connect the sensing line and the second node in response to a sensing gate signal and a light emitting element including a first electrode connected to the second node and a second electrode receiving a second power voltage. The scan gate signal may be the first gate signal, and a sensing gate signal may be the second gate signal.

According to embodiments, an electronic device may include a controller configured to output input image data and an input control signal, a display panel configured to display an image based on the input image data and a panel driver configured to drive the display panel based on the input image data and the input control signal. The display panel may include a plurality of pixels. The panel driver may include a gate driver configured to output first gate signals and second gate signals to the pixels. The gate driver may include a control signal generating block configured to generate a first common control signal based on a first carry signal and a second carry signal and generate a second common control signal based on a third carry signal and a fourth carry signal, an output control signal generating block configured to generate an output control signal based on a first input signal, a second input signal and a boosting control signal, a first gate signal output control block configured to generate a first output control voltage based on the output control signal, the first carry signal and the second carry signal, a first gate signal control block configured to output the first gate signals and the boosting control signal based on the first common control signal, the first output control voltage, a boosting clock signal and first clock signals, a second gate signal output control block configured to generate a second output control voltage based on the output control signal, the third carry signal and the fourth carry signal and a second gate signal control block configured to output the second gate signals based on the second common control signal, the second output control voltage, the boosting clock signal and second clock signals. The input control signal may include data selecting a driving mode of the display panel.

In an embodiment, when the input control signal includes data of the sensing driving, the first input signal may have an activation level, the boosting lock signal may have a clock high level, and the output control signal generating block may store the output control signal.

In an embodiment, when the input control signal includes data of the sensing driving, the second input signal may have an activation level, and the output control signal generating block may output the output control signal.

In an embodiment, when the input control signal includes data of the sensing driving, a sensing operation may be performed to at least one pixel of the pixels, and sensing gate signal applied to the at least one pixel may have an activation level.

According to the gate driver, the display device including the gate driver and the electronic device including the gate driver, a plurality of gate signals may be output based on the common control signal. Accordingly, the integration of the gate driver may be improved. Additionally, the gate signals may be output based on the common control signal, so that a reliability of the gate signals may be improved. Accordingly, a display quality of the display panel may be improved.

Additionally, the gate driver may output signals for performing a sensing operation based on input signals. Accordingly, a sensing operation may be performed on at least one pixel among a plurality of pixels. The sensing operation may be performed on at least one pixel, so that the display quality of the display panel can be further improved.

Additionally, the gate driver may be driven at a high frequency, so that the display quality of the display panel may be further improved.

Additionally, the display panel may be driven at variable frequencies, so that the power consumption of the display device may be reduced.

### BRIEF DESCRIPTION OF THE DRAWINGS

The above and other features and advantages of the present inventive concept will become more apparent by describing in detailed embodiments thereof with reference to the accompanying drawings.

FIG. 1 is a block diagram illustrating a display device according to an embodiment of the present inventive concept.

FIG. 2 is a block diagram illustrating a gate driver included in a display device of FIG. 1.

FIG. 3 is a block diagram illustrating an example of stage of FIG. 2.

FIG. 4 is a timing diagram illustrating an example of signals applied to a gate driver of FIG. 2.

FIG. 5A is a circuit diagram illustrating an example of a control signal generating block and an output control signal generating block of FIG. 3.

FIG. 5B is a circuit diagram illustrating an example of a first gate signal control block of FIG. 3.

FIG. 5C is a circuit diagram illustrating a first gate signal output control block of FIG. 3.

FIG. 5D is a circuit diagram illustrating an example of a second gate signal control block of FIG. 3.

FIG. 5E is a circuit diagram illustrating a second gate signal output control block of FIG. 3.

FIG. 6 is a timing diagram illustrating signals applied to a first gate signal output control block of FIG. 5C.

FIG. 7 is a timing diagram illustrating signals applied to a second gate signal output control block of FIG. 5E.

FIG. 8 is a timing diagram illustrating an example of signals applied to a gate driver of FIG. 2.

FIG. 9 is a timing diagram illustrating signals applied to a first gate signal output control block of FIG. 5C.

FIG. 10 is a timing diagram illustrating signals applied to a second gate signal output control block of FIG. 5E.

FIG. 11 is a circuit diagram illustrating of an operation of a control signal generating block and an output control signal generating block of FIG. 3 in a third period of FIG. 8.

FIG. 12 is a circuit diagram illustrating of an operation of a control signal generating block and an output control signal generating block of FIG. 3 in a fifth period of FIG. 8.

FIG. 13 is a circuit diagram illustrating an operation of a first gate signal output control block of FIG. 3 in a fifth period of FIG. 8.

FIG. 14 is a circuit diagram illustrating an operation of a second gate signal output control block of FIG. 3 in a fifth period of FIG. 8.

FIG. 15 is a circuit diagram illustrating an operation of a first gate signal control block of FIG. 3 in a sixth period of FIG. 8.

FIG. 16 is a circuit diagram illustrating an operation of a second gate signal control block of FIG. 3 in a sixth period of FIG. 8.

FIG. 17 is a timing diagram illustrating an example of signals applied to a gate driver of FIG. 2.

FIG. 18 is a timing diagram illustrating an example of signals applied to a gate driver of FIG. 2.

FIG. 19 is a timing diagram illustrating an example of signals applied to a gate driver of FIG .2.

FIG. 20 is a circuit diagram illustrating an example of pixel of FIG. 1.

FIG. 21 is a circuit diagram illustrating an example of a first gate signal control block of FIG. 3.

FIG. 22 is a circuit diagram illustrating an example of a second gate signal control block of FIG. 3.

FIG. 23 is a block diagram illustrating an example of an electronic device.

### DETAILED DESCRIPTION OF THE INVENTIVE CONCEPT

Hereinafter, the present inventive concept will be explained in detail with reference to the accompanying drawings.

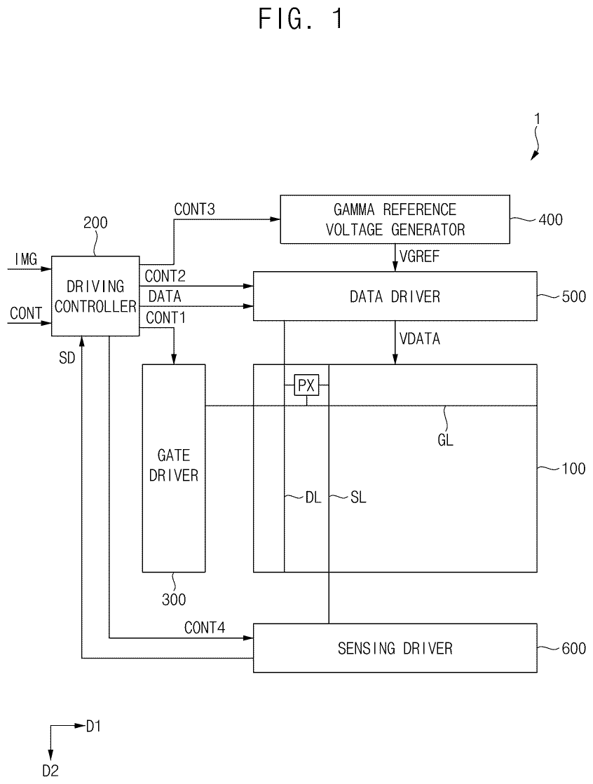

FIG. 1 is a block diagram illustrating an example of a display device 1 of FIG. 1.

Referring to FIG. 1, a display device 1 may include a display panel 100 and a panel driver. The panel driver may include a driving controller 200, a gate driver 300, a gamma reference voltage generator 400, a data driver 500 and a sensing driver 600.

The display panel 100 may have a display region on which an image is displayed and a peripheral region adjacent to the display region.

The display panel 100 may include a plurality of gate lines GL, a plurality of data lines DL, a plurality of sensing lines SL and a plurality of pixels PX electrically connected to the gate lines GL, the data lines DL and the sensing lines SL. The gate lines GL may extend in a first direction D1. The data lines DL may extend in a second direction D2 crossing the first direction D1. The sensing lines SL may extend in the second direction D2.

The driving controller 200 may receive input image data IMG and an input control signal CONT from an external apparatus. For example, the input image data IMG may include red image data, green image data and blue image data. The input image data IMG may include white image data. The input image data IMG may include magenta image data, cyan image data and yellow image data. The input control signal CONT may include a master clock signal and a data enable signal. The input control signal CONT may further include a vertical synchronizing signal and a horizontal synchronizing signal.

The driving controller 200 may generate a first control signal CONT1, a second control signal CONT2, a third control signal CONT3, a fourth control signal CONT4 and a data signal DATA based on the input image data IMG and the input control signal CONT.

The driving controller 200 may generate the first control signal CONT1 for controlling an operation of the gate driver 300 based on the input control signal CONT, and output the first control signal CONT1 to the gate driver 300. The first control signal CONT1 may include a vertical start signal and a gate clock signal.

The driving controller 200 may generate the second control signal CONT2 for controlling an operation of the data driver 500 based on the input control signal CONT, and output the second control signal CONT2 to the data driver 500. The second control signal CONT2 may include a horizontal start signal and a load signal.

The driving controller 200 may generate the data signal DATA based on the input image data IMG. The driving controller 200 may output the data signal DATA to the data driver 500.

The driving controller 200 may generate the third control signal CONT3 for controlling an operation of the gamma reference voltage generator 400 based on the input control signal CONT, and output the third control signal CONT3 to the gamma reference voltage generator 400.

The driving controller 200 may generate the fourth control signal CONT4 for controlling an operation of the sensing driver 600 based on the input control signal CONT, and output the fourth control signal CONT4 to the sensing driver 600.

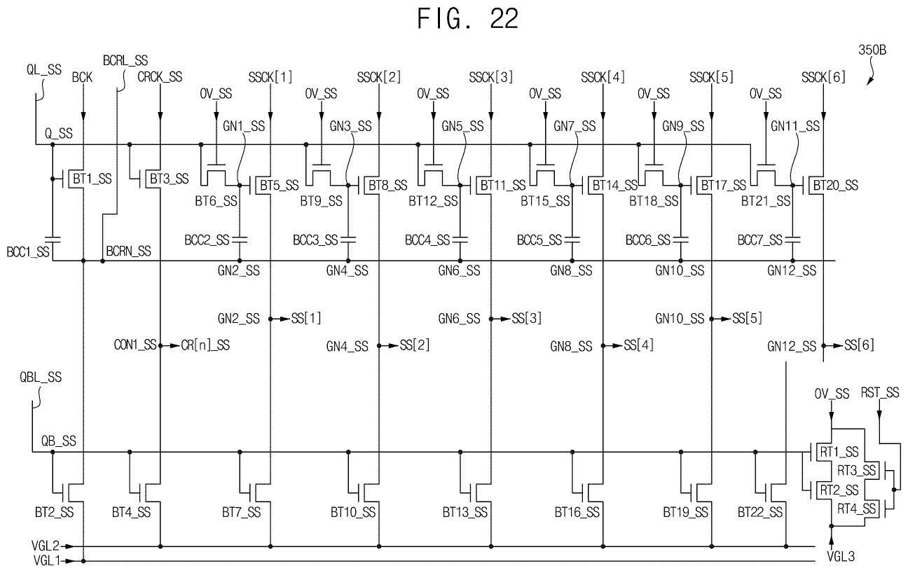

The gate driver 300 may generate gate signals driving the gate lines GL in response to the first control signal CONT1 received from the driving controller 200. For example, the gate signals may include first gate signals and second gate signals. For example, the first gate signals may be scan gate signals SC of FIG. 22. For example, the second gate signals may be sensing gate signals SS of FIG. 22. The gate driver 300 may output the gate signals to the gate lines GL.

In an embodiment, the gate driver 300 may be disposed in the peripheral region. In an embodiment, the gate driver 300 may be integrated in the peripheral region.

The gamma reference voltage generator 400 generates a gamma reference voltage VGREF in response to the third control signal CONT3 received from the driving controller 200. The gamma reference voltage generator 400 provides the gamma reference voltage VGREF to the data driver 500. The gamma reference voltage VGREF has a value corresponding to a level of the data signal DATA.

In an embodiment, the gamma reference voltage generator 400 may be disposed in the driving controller 200, or in the data driver 500.

The data driver 500 receives the second control signal CONT2 and the data signal DATA from the driving controller 200, and receives the gamma reference voltages VGREF from the gamma reference voltage generator 400. The data driver 500 converts the data signal DATA into data voltages VDATA having an analog type using the gamma reference voltages VGREF. The data driver 500 outputs the data voltages VDATA to the data lines DL.

In an embodiment, the data driver 500 may be disposed in the peripheral region. In an embodiment, the data driver 500 may be integrated in the peripheral region.

The sensing driver 600 may receive the fourth control signal CONT4 from the driving controller 200. The sensing driver 600 may generate sensing data SD by sensing the pixels PX through the sensing lines SL. For example, in a blank period, the sensing driver 600 may sense at least one pixel of the pixels PX. For example, the sensing driver 600 may sense a driving characteristic (e.g., a mobility and/or a threshold voltage) of a driving transistor by measuring a sensing current (or a sensing voltage) of the driving transistor of the pixels PX through the sensing line SL. For example, an operation sensing the driving characteristic (e.g., a mobility and/or a threshold voltage) of the driving transistor may be called a sensing operation.

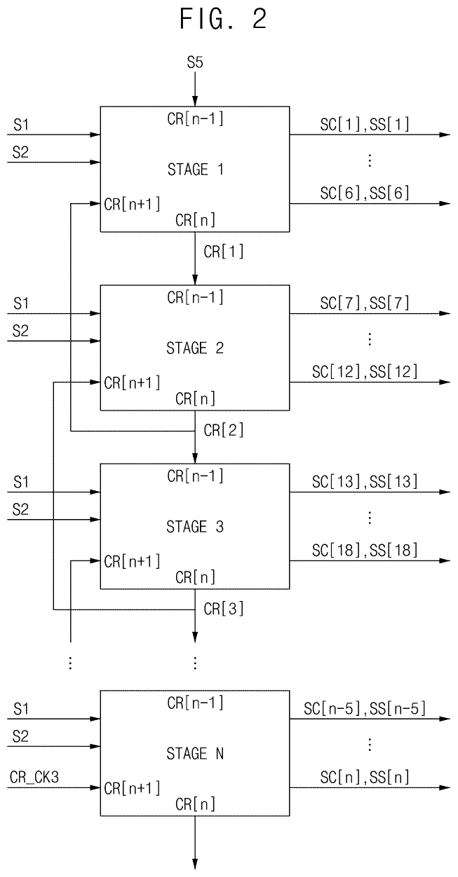

FIG. 2 is a block diagram illustrating a gate driver 300 included in a display device of FIG. 1.

Referring to FIG. 1 and FIG. 2, the gate driver 300 may include a plurality of stages STAGE 1, STAGE 2, STAGE 3 to STAGE N. At least one stage of the stages STAGE 1, STAGE 2, STAGE 3 to STAGE N may output gate signals based on a first input signal S1, a second input signal S2, first clock signals, second clock signals, a previous carry signal CR[n−1] and a next carry signal CR[n+1]. The at least one stage may receive clock signals corresponding to gate signals in which the at least one stage generates. However, the present inventive concept is not limited to the number of the gate signals in which the at least one stage outputs.

For example, the first stage STAGE 1 may output first to sixth scan gate signals SC[1] to SC[6] and first to sixth sensing gate signals SS[1] to SS[6]. The previous carry signal CR[n−1] of the first stage STAGE 1 may be a vertical start signal S5. The next carry signal CR[n+1] of the first stage STAGE 1 may be a second stage carry signal CR[2]. The first stage STAGE 1 may output first to sixth scan gate signals SC[1] to SC[6] and first to sixth sensing gate signals SS[1] to SS[6] based on the first input signal S1, the second input signal S2, the vertical start signal S5 and the second stage carry signal CR[2].

For example, the second stage STAGE 2 may output seventh to twelfth scan gate signals SC[7] to SC[12] and seventh to twelfth sensing gate signals SS[7] to SS[12]. The previous carry signal CR[n−1] of the second stage STAGE 2 may be a first stage carry signal CR[1]. The next carry signal CR[n+1] of the second stage STAGE 2 may be a third stage carry signal CR[3]. The second stage STAGE 2 may output seventh to twelfth scan gate signals SC[7] to SC[12] and seventh to twelfth sensing gate signals SS[7] to SS[12] based on the first input signal S1, the second input signal S2, the first stage carry signal CR[1] and the third stage carry signal CR[3].

For example, the third stage STAGE 3 may output thirteenth to eighteenth scan gate signals SC[13] to SC[18] and thirteenth to eighteenth sensing gate signals SS[13] to SS[18]. The previous carry signal CR[n−1] of the third stage STAGE 3 may be the second stage carry signal CR[2]. The next carry signal CR[n+1] of the third stage STAGE 3 may be a fourth stage carry signal. The third stage STAGE 3 may output thirteenth to eighteenth scan gate signals SC[13] to SC[18] and thirteenth to eighteenth sensing gate signals SS[13] to SS[18] based on the first input signal S1, the second input signal S2, the second stage carry signal CR[2] and the fourth stage carry signal.

For example, the N-th stage STAGE N may output N−5-th to N-th scan gate signals SC[n−5] to SC[n] and N−5-th to N-th sensing gate signals SS[n−5] to SS[n]. The previous carry signal CR[n−1] of the N-th stage STAGE N may be N−1-th stage carry signal. The next carry signal CR[n+1] of the N-th stage STAGE N may be a third carry signal CR_CK3. The N-th stage STAGE N may output N−5-th to N-th scan gate signals SC[n−5] to SC[n] and N−5-th to N-th sensing gate signals SS[n−5] to SS[n] based on the first input signal S1, the second input signal S2, the N−1-th stage carry signal and the third carry signal CR_CK3.

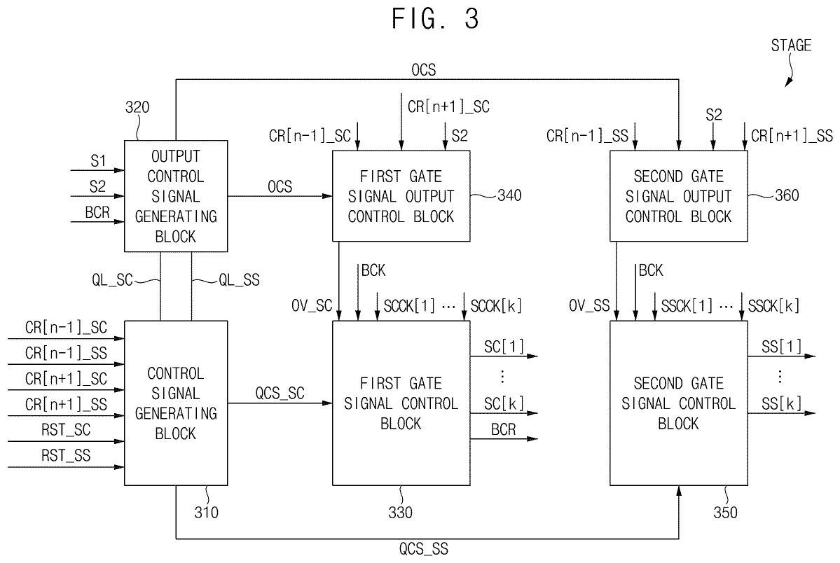

FIG. 3 is a block diagram illustrating an example of a stage STAGE of FIG. 2.

Referring to FIG. 1 to FIG. 3, the stage STAGE included in the gate driver 300 may include a control signal generating block 310, an output control signal generating block 320, a first gate signal control block 330, a first gate signal output control block 340, a second gate signal control block 350 and a second gate signal output control block 360.

The control signal generating block 310 may receive a previous first carry signal CR[n−1]_SC, a previous second carry signal CR[n−1]_SS, a next first carry signal CR[n+1]_SC, a next second carry signal CR[n+1]_SS, a first reset signal RST_SC and a second reset signal RST_SS. The control signal generating block 310 may generate a first common control signal QCS_SC based on the previous first carry signal CR[n−1]_SC, the next first carry signal CR[n+1]_SC, and the first reset signal RST_SC. The control signal generating block 310 may output the first common control signal QCS_SC to the first gate signal control block 330. The first common control signal QCS_SC may be applied to the first common control line QL_SC. The control signal generating block 310 may generate a second common control signal QCS_SS based on the previous second carry signal CR[n−1]_SS, the next second carry signal CR[n+1]_SS and the second reset signal RST_SS. The control signal generating block 310 may output the second common control signal QCS_SS to the second gate signal control block 350. The second common control signal QCS_SS may be applied to a second common control line QL_SS.

The output control signal generating block 320 may receive the first input signal S1, the second input signal S2 and a boosting control signal BCR. The output control signal generating block 320 and the control signal generating block 310 may be connected through the first common control line QL_SC. The output control signal generating block 320 and the control signal generating block 310 may be connected through the second common control line QL_SS. The output control signal generating block 320 may generate an output control signal OCS based on the first input signal S1, the second input signal S2 and the boosting control signal BCR. The output control signal generating block 320 may output the output control signal OCS to the first gate signal output control block 340. The output control signal generating block 320 may output the output control signal OCS to the second gate signal output control block 360.

The first gate signal control block 330 may receive the first common control signal QCS_SC, a first output control voltage OV_SC, a boosting clock signal BCK and first gate clock signals SCCK[1] to SCCK[k]. The first gate signal control block 330 may generate the first gate signals SC[1] to SC[k] and the boosting control signal BCR based on the first common control signal QCS_SC, the first output control voltage OV_SC, the boosting clock signal BCK, and the first gate clock signals SCCK[1] to SCCK[k]. The first output control voltage OV_SC may have a first high voltage or a second high voltage lower than the first high voltage. When the first output control voltage OV_SC has the first high voltage, the first gate signals SC[1] to SC[k] having an activation level may be output. When the first output control voltage OV_SC has the second high voltage, the first gate signals SC[1] to SC[k] may have an inactivation level. For example, the first gate signals SC[1] to SC[k] having an activation level may be sequentially output. For example, the first gate signals SC[1] to SC[k] may mean scan gate signals. For example, when the first output control voltage OV_SC has the first high voltage, the first to K-th scan gate signals having an activation level may be sequentially output. For example, when the first output control voltage OV_SC has the first high voltage, the first gate signals SC[1] to SC[k] corresponding to the first gate clock signals SCCK[1] to SCCK[k] may be output. For example, when the first output control voltage OV_SC has the second high voltage, the first to K-th scan gate signals may have an inactivation level. The first gate signal control block 330 may output the boosting control signal BCR based on the boosting clock signal BCK.

The first gate signal output control block 340 may receive the output control signal OCS, the previous first carry signal CR[n−1]_SC, the second input signal S2 and the next first carry signal CR[n+1]_SC. The first gate signal output control block 340 may output the first output control voltage OV_SC based on the output control signal OCS, the previous first carry signal CR[n−1]_SC and the next first carry signal CR[n+1]_SC.

The second gate signal control block 350 may receive the second common control signal QCS_SS, the second output control voltage OV_SS, the boosting clock signal BCK, and second gate clock signals SSCK[1] to SSCK[k]. The second gate signal control block 350 may generate second gate signals SS[1] to SS[k] based on the second common control signal QCS_SS, the second output control voltage OV_SS, the boosting clock signal BCK, and second gate clock signals SSCK[1] to SSCK[k]. The second output control voltage OV_SS may have the first high voltage or the second high voltage. When the second output control voltage OV_SS has the first high voltage, the second gate signals SS[1] to SS[k] having an activation level may be output. When the second output control voltage OV_SS has the second high voltage, the second gate signals SS[1] to SS[k] may have an inactivation level. For example, the second gate signals SS[1] to SS[k] having an activation level may be sequentially output. For example, the second gate signals SS[1] to SS[k] may mean sensing gate signals. For example, when the second output control voltage OV_SS has the first high voltage, the first to Kth sensing gate signals having an activation level may be sequentially output. For example, when the second output control voltage OV_SS has the first high voltage, the second gate signals SS[1] to SS[k] corresponding to the second gate clock signals SSCK[1] to SSCK[k] may be output. For example, when the second output control voltage OV_SS has the second high voltage, the first to K-th sensing gate signals may have inactivation levels.

The second gate signal output control block 360 may receive the output control signal OCS, the previous second carry signal CR[n−1]_SS, second input signal S2 and the next second carry signal CR[n+1]_SS. The second gate signal output control block 360 may output the second output control voltage OV_SS based on the output control signal OCS, the previous second carry signal CR[n−1]_SS and the next second carry signal CR[n+1]_SS.

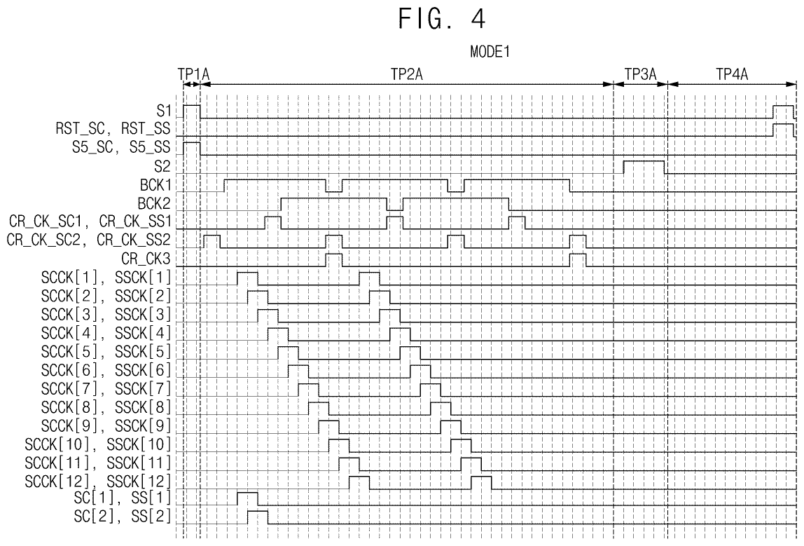

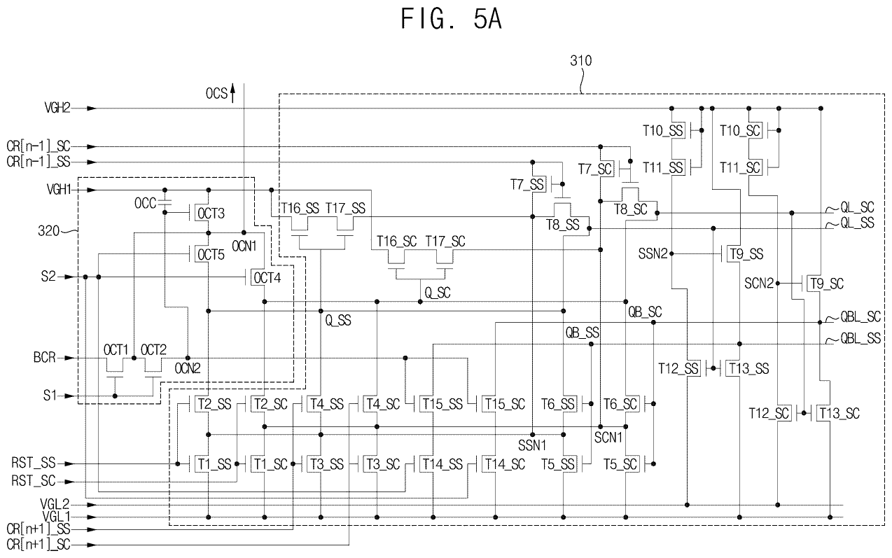

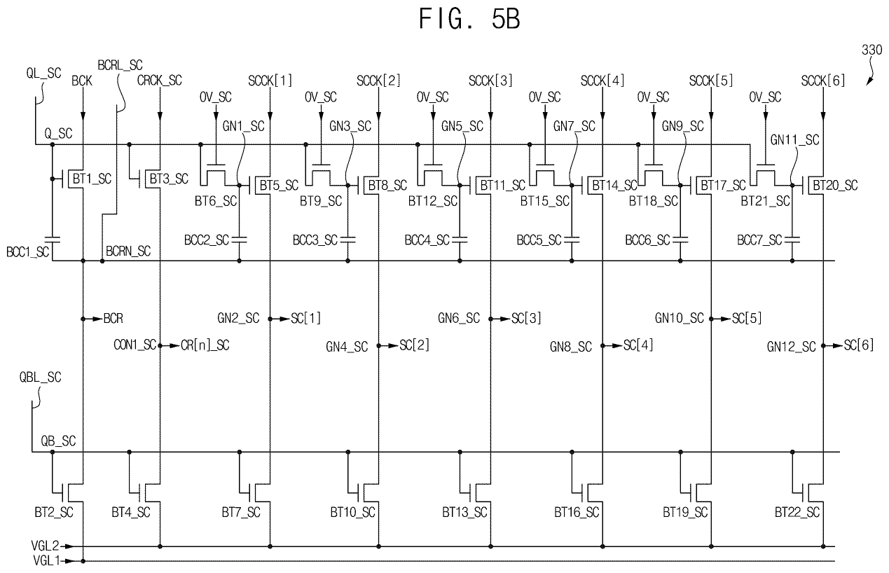

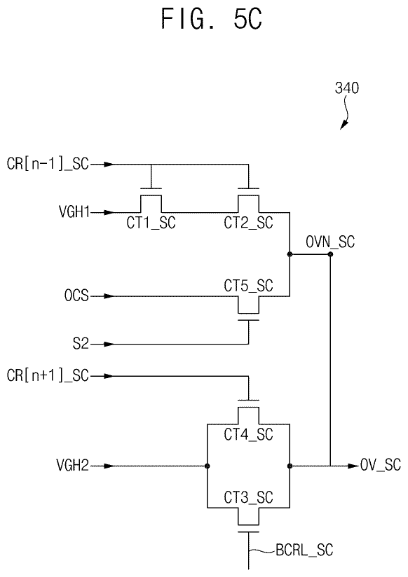

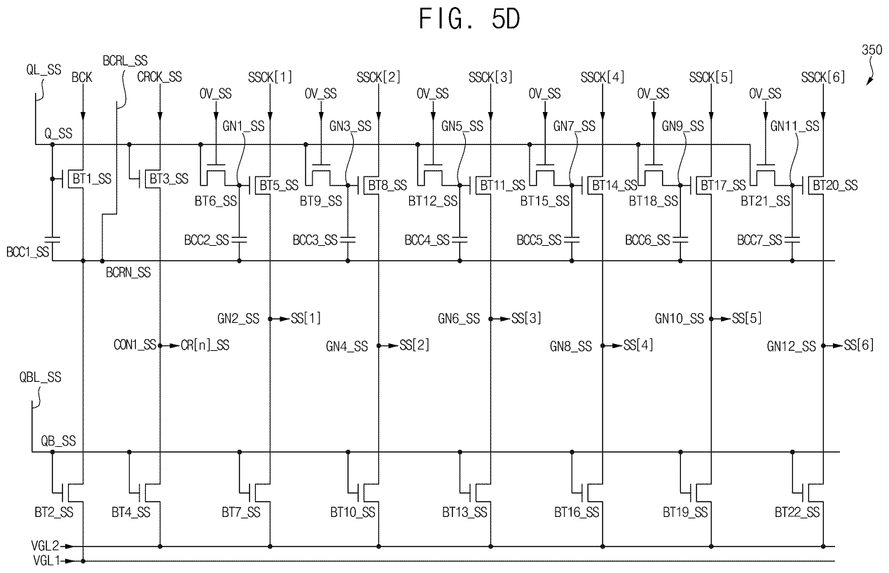

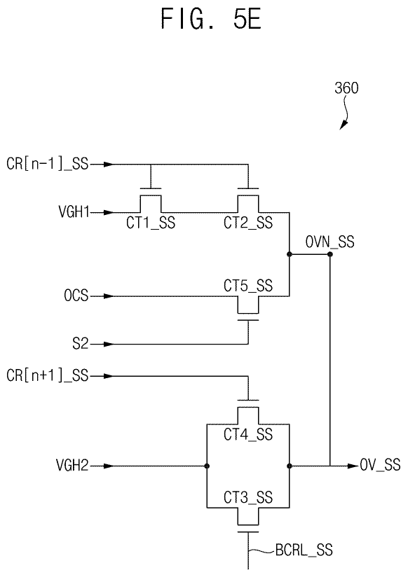

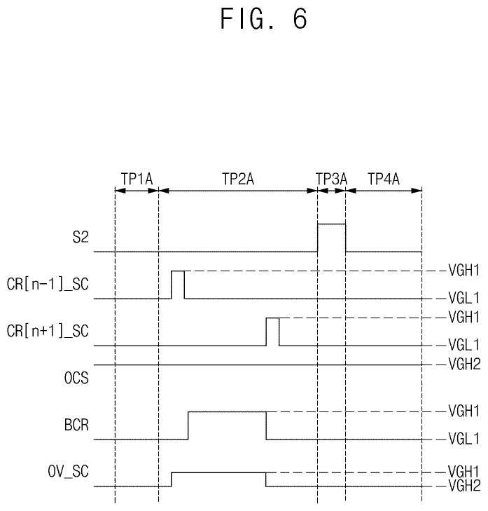

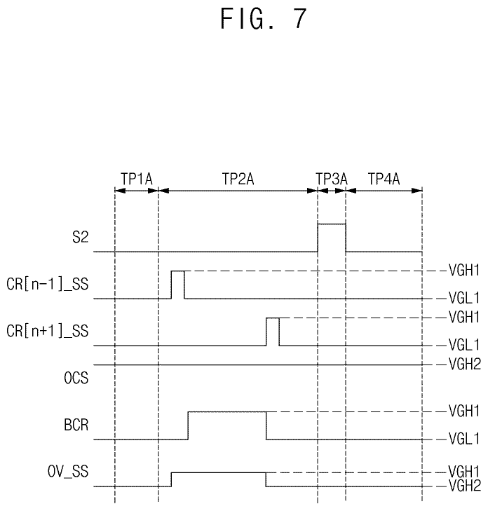

FIG. 4 is a timing diagram illustrating an example of signals applied to a gate driver 300 of FIG. 2. FIG. 5A is a circuit diagram illustrating an example of a control signal generating block 310 and an output control signal generating block 320 of FIG. 3. FIG. 5B is a circuit diagram illustrating an example of a first gate signal control block 330 of FIG. 3. FIG. 5C is a circuit diagram illustrating a first gate signal output control block 340 of FIG. 3. FIG. 5D is a circuit diagram illustrating an example of a second gate signal control block 350 of FIG. 3. FIG. 5E is a circuit diagram illustrating a second gate signal output control block 360 of FIG. 3. FIG. 6 is a timing diagram illustrating signals applied to the first gate signal output control block 340 of FIG. 5C. FIG. 7 is a timing diagram illustrating signals applied to the second gate signal output control block 360 of FIG. 5E.

Referring to FIG. 4, a frame period in which the gate driver 300 is driven may include first to fourth periods TP1A, TP2A, TP3A and TP4A. For example, the frame period in which the gate driver 300 is driven may include an active period in which the gate signals are output and a blank period. In the present embodiment, the active period may include the first to third periods TP1A, TP2A and TP3A. The blank period may include the fourth period TP4A. For example, an operation of the gate driver during the frame period including the first to fourth periods TP1A, TP2A, TP3A and TP4A may be called as a first operation MODE 1. For example, the first operation MODE 1 may be called as a normal operation.

Referring to FIG. 1 to FIG. 7, the control signal generating block 310 may include first to seventeenth scan gate transistors T1_SC, T2_SC, T3_SC, T4_SC, T5_SC, T6_SC, T7_SC, T8_SC, T9_SC, T10_SC, T11_SC, T12_SC, T13_SC, T14_SC, T15_SC, T16_SC and T17_SC.

The first scan gate transistor T1_SC may include a control electrode receiving the first reset signal RST_SC, a first electrode connected to a first scan node SCN1 and a second electrode receiving a first low voltage VGL1. The first scan gate transistor T1_SC may apply the first low voltage VGL1 to the first scan node SCN1 in response to the first reset signal RST_SC. For example, the first scan gate transistor T1_SC may initialize the first scan node SCN1 to the first low voltage VGL1 in response to the first reset signal RST_SC.

The second scan gate transistor T2_SC may include a control electrode receiving the first reset signal RST_SC, a first electrode connected to a first common control node Q_SC, and a second electrode connected to the first scan node SCN1. The second scan gate transistor T2_SC may connect the first common control node Q_SC and the first scan node SCN1 in response to the first reset signal RST_SC. Accordingly, the first common control node Q_SC may be initialized to the first low voltage VGL1 in response to the first reset signal RST_SC.

The third scan gate transistor T3_SC may include a control electrode receiving the first carry signal CR[n+1]_SC, a first electrode connected to the first scan node SCN1 and a second electrode receiving the first low voltage VGL1. The third scan gate transistor T3_SC may apply the first low voltage VGL1 to the first scan node SCN1 in response to the first carry signal CR[n+1]_SC. For example, the third scan gate transistor T3_SC may initialize the first scan node SCN1 to the first low voltage VGL1 in response to the first carry signal CR[n+1]_SC.

The fourth scan gate transistor T4_SC may include a control electrode receiving the next first carry signal CR[n+1]_SC, a first electrode connected to the first common control node Q_SC and a second electrode connected to the first scan node SCN1. The fourth scan gate transistor T4_SC may connect the first common control node Q_SC and the first scan node SCN1 in response to the next first carry signal CR[n+1]_SC. Accordingly, the first common control node Q_SC may be initialized to the first low voltage VGL1 in response to the next first carry signal CR[n+1]_SC.

The fifth scan gate transistor T5_SC may include a control electrode connected to first inverting common control node QB_SC, a first electrode connected to the first scan node SCN1 and a second electrode receiving first low voltage VGL1. The fifth scan gate transistor T5_SC may apply the first low voltage VGL1 to the first scan node SCN1 in response to the voltage of the first inverting common control node QB_SC.

The sixth scan gate transistor T6_SC may include a control electrode connected to the first inverting common control node QB_SC, a first electrode connected to the first inverting common control node QB_SC and a second electrode connected to the first scan node SCN1. The sixth scan gate transistor T6_SC may connect the first inverting common control node QB_SC and the first scan node SCN1 in response to a voltage of the first inverting common control node QB_SC. The first inverting common control node QB_SC may be connected to the first inverting common control line QBL_SC.

The seventh scan gate transistor T7_SC may include a control electrode receiving the previous first carry signal CR[n−1]_SC, a first electrode receiving the previous first carry signal CR[n−1]_SC and a second electrode connected to the first scan node SCN1.

The eighth scan gate transistor T8_SC may include a control electrode receiving the previous first carry signal CR[n−1]_SC, a first electrode connected to the first scan node SCN1 and a second electrode connected to the first common control node Q_SC. The eighth scan gate transistor T8_SC may connect the first scan node SCN1 and the first common control node Q_SC in response to the previous first carry signal CR[n−1]_SC. The first common control node Q_SC may be connected to the first common control line QL_SC.

The ninth scan gate transistor T9_SC may include a control electrode connected to a second scan node SCN2, a first electrode receiving the second high voltage VGH2 and a second electrode connected to a first electrode of the thirteenth scan gate transistor T13_SC.

The tenth scan gate transistor T10_SC may include a control electrode receiving the second high voltage VGH2, a first electrode receiving the second high voltage VGH2 and a second electrode connected to a first electrode of the eleventh scan gate transistor T11_SC. The eleventh scan gate transistor T11_SC may include a control electrode receiving the second high voltage VGH2, the first electrode connected to the second electrode of the tenth scan gate transistor T10_SC and a second electrode connected to the second scan node SCN2. The tenth scan gate transistor T10_SC and the eleventh scan gate transistor T11_SC may be connected in series. In an embodiment, the tenth scan gate transistor T10_SC and the eleventh scan gate transistor T11_SC may be configured as a single transistor.

The twelfth scan gate transistor T12_SC may include a control electrode connected to the first common control node Q_SC, a first electrode connected to the second scan node SCN2 and a second electrode receiving the second low voltage VGL2. The second low voltage VGL2 may be higher than the first low voltage VGL1. For example, the first low voltage VGL1 may be about −9 V. For example, the second low voltage VGL2 may be about −5 V. However, the present inventive concept is not limited to values of the first low voltage VGL1 and the second low voltage VGL2.

The thirteenth scan gate transistor T13_SC may include a control electrode connected to the first common control node Q_SC, a first electrode connected to the second electrode of the ninth scan gate transistor T9_SC and a second electrode receiving the first low voltage VGL1.

The fourteenth scan gate transistor T14_SC may include a control electrode receiving the second input signal S2, a first electrode connected to a second electrode of the fifteenth scan gate transistor T15_SC and a second electrode receiving the first low voltage VGL1.

The fifteenth scan gate transistor T15_SC may include a control electrode receiving the boosting control signal BCR, a first electrode connected to the first inverting common control node QB_SC and a second electrode connected to the first electrode of the fourteenth scan gate transistor T14_SC.

The sixteenth scan gate transistor T16_SC may include a control electrode connected to the first common control node Q_SC, a first electrode receiving the first high voltage VGH1 and a second electrode connected to the first electrode of the seventeenth scan gate transistor T17_SC. The seventeenth scan gate transistor T17_SC may include a control electrode connected to the first common control node Q_SC, the first electrode connected to the second electrode of the sixteenth scan gate transistor T16_SC and a second electrode connected to the first scan node SCN1. Accordingly, the first high voltage VGH1 may be applied to the first scan node SCN1 in response to a voltage of the first common control node Q_SC. The sixteenth scan gate transistor T16_SC and the seventeenth scan gate transistor T17_SC may be connected in series. In an embodiment, the sixteenth scan gate transistor T16_SC and the seventeenth scan gate transistor T17_SC may be formed as a single transistor. The first high voltage VGH1 may be higher than the second high voltage VGH2. For example, the first high voltage VGH1 may be about 25 V. For example, the second high voltage VGH2 may be about 15 V. However, the present inventive concept is not limited to value of the first high voltage VGH1 and the value of the second high voltage VGH2.

In the present embodiment, the first common control node Q_SC may output the first common control signal QCS_SC. The first common control signal QCS_SC may be applied to the first common control line QL_SC.

The output control signal generating block 320 may include first to fifth output control transistors OCT1, OCT2, OCT3, OCT4 and OCT5 and an output control capacitor OCC.

The first output control transistor OCT1 may include a control electrode receiving the first input signal S1, a first electrode receiving the boosting control signal BCR and a second electrode connected to a first output control node OCN1. The first output control transistor OCT1 may apply the boosting control signal BCR to the first output control node OCN1 in response to the first input signal S1.

The second output control transistor OCT2 may include a control electrode receiving the first input signal S1, a first electrode connected to the first output control node OCN1 and a second electrode connected to a second output control node OCN2. The second output control transistor OCT2 may connect the first output control node OCN1 and the second output control node OCN2 in response to the first input signal S1. For example, the second output control transistor OCT2 may apply the boosting control signal BCR to the second output control node OCN2 in response to the first input signal S1.

The third output control transistor OCT3 may include a control electrode connected to the second output control node OCN2, a first electrode receiving the first high voltage VGH1 and a second electrode connected to the first output control node OCN1. The third output control transistor OCT3 may apply the first high voltage VGH1 to the first output control node OCN1 in response to a voltage of the second output control node OCN2.

The fourth output control transistor OCT4 may include a control electrode receiving the second input signal S2, a first electrode connected to the first output control node OCN1 and a second electrode connected to the first common control node Q_SC. The fourth output control transistor OCT4 may connect the first output control node OCN1 and the first common control node Q_SC in response to the second input signal S2.

The fifth output control transistor OCT5 may include a control electrode receiving the second input signal S2, a first electrode connected to the first output control node OCN1 and a second electrode connected to the second common control node Q_SS. The fifth output control transistor OCT5 may connect the first output control node OCN1 and the second common control node Q_SS in response to the second input signal S2.

The output control capacitor OCC may include a first electrode receiving the first high voltage VGH1 and a second electrode connected to the second output control node OCN2. The output control capacitor OCC may store a voltage of the second output control node OCN2. For example, the second output control node OCN2 may store the boosting control signal BCR applied to the second output control node OCN2.

In the present embodiment, the first output control node OCN1 may output the output control signal OCS. The first gate signal control block 330 may include first to twenty-second signal generating transistors BT1_SC, BT2_SC, BT3_SC, BT4_SC, BT5_SC, BT6_SC, BT7_SC, BT8_SC, BT9_SC, BT10_SC, BT11_SC, BT12_SC, BT13_SC, BT14_SC, BT15_SC, BT16_SC, BT17_SC, BT18_SC, BT19_SC, BT20_SC, BT21_SC and BT22_SC and first to seventh boosting capacitors BCC1_SC, BCC2_SC, BCC3_SC, BCC4_SC, BCC5_SC, BCC6_SC and BCC7_SC.

The first signal generating transistor BT1_SC may include a control electrode connected to the first common control line QL_SC, a first electrode receiving the boosting clock signal BCK and a second electrode connected to a boosting control node BCRN_SC. The first signal generating transistor BT1_SC may apply the boosting clock signal BCK to the boosting control node BCRN_SC in response to the first common control signal QCS_SC. The boosting control node BCRN_SC may output the boosting control signal BCR. The boosting control node BCRN_SC may be connected to the boosting control line BCRL_SC.

The second signal generating transistor BT2_SC may include a control electrode connected to the first inverting common control line QBL_SC, a first electrode connected to the boosting control node BCRN_SC and a second electrode receiving the first low voltage VGL1. The second signal generating transistor BT2_SC may apply the first low voltage VGL1 to the boosting control node BCRN_SC in response to a voltage of the first inverting common control node QB_SC.

The third signal generating transistor BT3_SC may include a control electrode connected to the first common control line QL_SC, a first electrode receiving a first carry clock signal CRCK_SC and a second electrode connected to a first carry output node CON1_SC. The first carry output node CON1_SC may output a first carry signal CR[n]_SC.

The fourth signal generating transistor BT4_SC may include a control electrode connected to the first inverting common control line QBL_SC, a first electrode connected to the first carry output node CON1_SC and a second electrode receiving the second low voltage VGL2. The fourth signal generating transistor BT4_SC may apply the second low voltage VGL2 to the first carry output node CON1_SC in response to a voltage of the first inverting common control node QB_SC.

The fifth signal generating transistor BT5_SC may include a control electrode connected to a first signal generating node GN1_SC, a first electrode receiving a first scan clock signal SCCK[1] and a second electrode connected to a second signal generating node GN2_SC. The fifth signal generating transistor BT5_SC may apply the first scan clock signal SCCK[1] to the second signal generating node GN2_SC in response to a voltage of the first signal generating node GN1_SC. The second signal generating node GN2_SC may output a first scan gate signal SC[1].

The sixth signal generating transistor BT6_SC may include a control electrode receiving the first output control voltage OV_SC, a first electrode connected to the first common control line QL_SC and a second electrode connected to the first signal generating node GN1_SC. The sixth signal generating transistor BT6_SC may apply the first common control signal QCS_SC to the first signal generating node GN1_SC in response to the first output control voltage OV_SC. When the first output control voltage OV_SC has the first high voltage VGH1, the sixth signal generating transistor BT6_SC may be turned on. The sixth signal generating transistor BT6_SC may be turned on, so that the first common control signal QCS_SC may be applied to the first signal generating node GN1_SC. The first common control signal QCS_SC may be applied to the first signal generating node GN1_SC, so that the fifth signal generating transistor BT5_SC may be turned on. Accordingly, the first scan clock signal SCCK[1] may be applied to the second signal generating node GN2_SC. Accordingly, the first scan gate signal SC[1] corresponding to the first scan clock signal SCCK[1] may be output. When the first output control voltage OV_SC has the second high voltage VGH2, the sixth signal generating transistor BT6_SC may be turned off.

The seventh signal generating transistor BT7_SC may include a control electrode connected to the first inverting common control line QBL_SC, a first electrode connected to the second signal generating node GN2_SC and a second electrode receiving the second low voltage VGL2. The seventh signal generating transistor BT7_SC may apply the second low voltage VGL2 to the second signal generating node GN2_SC in response to a voltage of the first inverting common control node QB_SC.

The eighth signal generating transistor BT8_SC may include a control electrode connected to a third signal generating node GN3_SC, a first electrode receiving a second scan clock signal SCCK[2] and a second electrode connected to a fourth signal generating node GN4_SC. The eighth signal generating transistor BT8_SC may apply the second scan clock signal SCCK[2] to the fourth signal generating node GN4_SC in response to a voltage of the third signal generating node GN3_SC. The fourth signal generating node GN4_SC may output a second scan gate signal SC[2].

The ninth signal generating transistor BT9_SC may include a control electrode receiving the first output control voltage OV_SC, a first electrode connected to the first common control line QL_SC, and a second electrode connected to the third signal generating node GN3_SC. The ninth signal generating transistor BT9_SC may apply the first common control signal QCS_SC to the third signal generating node GN3_SC in response to the first output control voltage OV_SC. When the first output control voltage OV_SC has the first high voltage VGH1, the ninth signal generating transistor BT9_SC may be turned on. The ninth signal generating transistor BT9_SC may be turned on, so that the first common control signal QCS_SC may be applied to the third signal generating node GN3_SC. The first common control signal QCS_SC may be applied to the third signal generating node GN3_SC, so that the eighth signal generating transistor BT8_SC may be turned on. Accordingly, the second scan clock signal SCCK[2] may be applied to the fourth signal generating node GN4_SC. Accordingly, the second scan gate signal SC[2] corresponding to the second scan clock signal SCCK[2] may be output. When the first output control voltage OV_SC has the second high voltage VGH2, the ninth signal generating transistor BT9_SC may be turned off.

The tenth signal generating transistor BT10_SC may include a control electrode connected to the first inverting common control line QBL_SC, a first electrode connected to the fourth signal generating node GN4_SC and a second electrode receiving the second low voltage VGL2. The tenth signal generating transistor BT10_SC may apply the second low voltage VGL2 to the fourth signal generating node GN4_SC in response to a voltage of the first inverting common control node QB_SC.

The eleventh signal generating transistor BT11_SC may include a control electrode connected to the fifth signal generating node GN5_SC, a first electrode receiving a third scan clock signal SCCK[3] and a second electrode connected to a sixth signal generating node GN6_SC. The eleventh signal generating transistor BT11_SC may apply the third scan clock signal SCCK[3] to the sixth signal generating node GN6_SC in response to a voltage of the fifth signal generating node GN5_SC. The sixth signal generating node GN6_SC may output a third scan gate signal SC[3].

The twelfth signal generating transistor BT12_SC may include a control electrode receiving the first output control voltage OV_SC, a first electrode connected to the first common control line QL_SC and a second electrode connected to the fifth signal generating node GN5_SC. The twelfth signal generating transistor BT12_SC may apply the first common control signal QCS_SC to the fifth signal generating node GN5_SC in response to the first output control voltage OV_SC. When the first output control voltage OV_SC has the first high voltage VGH1, the twelfth signal generating transistor BT12_SC may be turned on. The twelfth signal generating transistor BT12_SC may be turned on, so that the first common control signal QCS_SC may be applied to the fifth signal generating node GN5_SC. The first common control signal QCS_SC may be applied to the fifth signal generating node GN5_SC, so that the eleventh signal generating transistor BT11_SC may be turned on. Accordingly, the third scan clock signal SCCK[3] may be applied to the sixth signal generating node GN6_SC. Accordingly, the third scan gate signal SC[3] corresponding to the third scan clock signal SCCK[3] may be output. When the first output control voltage OV_SC has the second high voltage VGH2, the twelfth signal generating transistor BT12_SC may be turned off.

The thirteenth signal generating transistor BT13_SC may include a control electrode connected to the first inverting common control line QBL_SC, a first electrode connected to the sixth signal generating node GN6_SC and a second electrode receiving the second low voltage VGL2. The thirteenth signal generating transistor BT13_SC may apply the second low voltage VGL2 to the sixth signal generating node GN6_SC in response to a voltage of the first inverting common control node QB_SC.

The fourteenth signal generating transistor BT14_SC may include a control electrode connected to the seventh signal generating node GN7_SC, a first electrode receiving a fourth scan clock signal SCCK[4] and a second electrode connected to the eighth signal generating node GN8_SC. The fourteenth signal generating transistor BT14_SC may apply the fourth scan clock signal SCCK[4] to the eighth signal generating node GN8_SC in response to a voltage of the seventh signal generating node GN7_SC. The eighth signal generating node GN8_SC may output the fourth scan gate signal SC[4].

The fifteenth signal generating transistor BT15_SC may include a control electrode receiving the first output control voltage OV_SC, a first electrode connected to the first common control line QL_SC and a second electrode connected to a seventh signal generating node GN7_SC. The fifteenth signal generating transistor BT15_SC may apply the first common control signal QCS_SC to the seventh signal generating node GN7_SC in response to the first output control voltage OV_SC. When the first output control voltage OV_SC has the first high voltage VGH1, the fifteenth signal generating transistor BT15_SC may be turned on. The fifteenth signal generating transistor BT15_SC may be turned on, so that the first common control signal QCS_SC may be applied to the seventh signal generating node GN7_SC. The first common control signal QCS_SC may be applied to the seventh signal generating node GN7_SC, so that the fourteenth signal generating transistor BT14_SC may be turned on. Accordingly, the fourth scan clock signal SCCK[4] may be applied to the eighth signal generating node GN8_SC. Accordingly, the fourth scan gate signal SC[4] corresponding to the fourth scan clock signal SCCK[4] may be output. When the first output control voltage OV_SC has the second high voltage VGH2, the fifteenth signal generating transistor BT15_SC may be turned off.

The sixteenth signal generating transistor BT16_SC may include a control electrode connected to the first inverting common control line QBL_SC, a first electrode connected to the eighth signal generating node GN8_SC and a second electrode receiving the second low voltage VGL2. The sixteenth signal generating transistor BT16_SC may apply the second low voltage VGL2 to the eighth signal generating node GN8_SC in response to a voltage of the first inverting common control node QB_SC.

The seventeenth signal generating transistor BT17_SC may include a control electrode connected to the ninth signal generating node GN9_SC, a first electrode receiving a fifth scan clock signal SCCK[5] and a second electrode connected to the tenth signal generating node GN10_SC. The seventeenth signal generating transistor BT17_SC may apply the fifth scan clock signal SCCK[5] to the tenth signal generating node GN10_SC in response to a voltage of the ninth signal generating node GN9_SC. The tenth signal generating node GN10_SC may output the fifth scan gate signal SC[5].

The eighteenth signal generating transistor BT18_SC may include a control electrode receiving the first output control voltage OV_SC, a first electrode connected to the first common control line QL_SC and a second electrode connected to a ninth signal generating node GN9_SC. The eighteenth signal generating transistor BT18_SC may apply the first common control signal QCS_SC to the ninth signal generating node GN9_SC in response to the first output control voltage OV_SC. When the first output control voltage OV_SC has the first high voltage VGH1, the eighteenth signal generating transistor BT18_SC may be turned on. The eighteenth signal generating transistor BT18_SC may be turned on, so that the first common control signal QCS_SC may be applied to the ninth signal generating node GN9_SC. The first common control signal QCS_SC may be applied to the ninth signal generating node GN9_SC, the seventeenth signal generating transistor BT17_SC may be turned on. Accordingly, the fifth scan clock signal SCCK[5] may be applied to the tenth signal generating node GN10_SC. Accordingly, the fifth scan gate signal SC[5] corresponding to the fifth scan clock signal SCCK[5] may be output. When the first output control voltage OV_SC has the second high voltage VGH2, the eighteenth signal generating transistor BT18_SC may be turned off.

The nineteenth signal generating transistor BT19_SC may include a control electrode connected to the first inverting common control line QBL_SC, a first electrode connected to the tenth signal generating node GN10_SC and a second electrode receiving the second low voltage VGL2. The nineteenth signal generating transistor BT19_SC may apply the second low voltage VGL2 to the tenth signal generating node GN10_SC in response to a voltage of the first inverting common control node QB_SC.

The twentieth signal generating transistor BT20_SC may include a control electrode connected to an eleventh signal generating node GN11_SC, a first electrode receiving a sixth scan clock signal SCCK[6] and a second electrode connected to a twelfth signal generating node GN12_SC. The twentieth signal generating transistor BT20_SC may apply the sixth scan clock signal SCCK[6] to the twelfth signal generating node GN12_SC in response to a voltage of the eleventh signal generating node GN11_SC. The twelfth signal generating node GN12_SC may output the sixth scan gate signal SC[6].

The twenty-first signal generating transistor BT21_SC may include a control electrode receiving the first output control voltage OV_SC, a first electrode connected to the first common control line QL_SC and a second electrode connected to the eleventh signal generating node GN11_SC. The twenty-first signal generating transistor BT21_SC may apply the first common control signal QCS_SC to the eleventh signal generating node GN11_SC in response to the first output control voltage OV_SC. When the first output control voltage OV_SC has the first high voltage VGH1, the twenty-first signal generating transistor BT21_SC may be turned on. The twenty-first signal generating transistor BT21_SC may be turned on, so that the first common control signal QCS_SC may be applied to the eleventh signal generating node GN11_SC. The first common control signal QCS_SC may be applied to the eleventh signal generating node GN11_SC, the twentieth signal generating transistor BT20_SC may be turned on. Accordingly, the sixth scan clock signal SCCK[6] may be applied to the twelfth signal generating node GN12_SC. Accordingly, the sixth scan gate signal SC[6] corresponding to the sixth scan clock signal SCCK[6] may be output. When the first output control voltage OV_SC has the second high voltage VGH2, the twenty-first signal generating transistor BT21_SC may be turned off.

The twenty-second signal generating transistor BT22_SC may include a control electrode connected to the first inverting common control line QBL_SC, a first electrode connected to the twelfth signal generating node GN12_SC and a second electrode receiving the second low voltage VGL2. The twenty-second signal generating transistor BT22_SC may apply the second low voltage VGL2 to the twelfth signal generating node GN12_SC in response to a voltage of the first inverting common control node QB_SC.

The first boosting capacitor BCC1_SC may include a first electrode connected to the first common control node Q_SC and a second electrode connected to the boosting control node BCRN_SC. The second boosting capacitor BCC2_SC may include a first electrode connected to the first signal generating node GN1_SC and a second electrode connected to the boosting control node BCRN_SC. The third boosting capacitor BCC3_SC may include a first electrode connected to the third signal generating node GN3_SC and a second electrode connected to the boosting control node BCRN_SC. The fourth boosting capacitor BCC4_SC may include a first electrode connected to the fifth signal generating node GN5_SC and a second electrode connected to the boosting control node BCRN_SC. The fifth boosting capacitor BCC5_SC may include a first electrode connected to the seventh signal generating node GN7_SC and a second electrode connected to the boosting control node BCRN_SC. The sixth boosting capacitor BCC6_SC may include a first electrode connected to the ninth signal generating node GN9_SC and a second electrode connected to the boosting control node BCRN_SC. The seventh boosting capacitor BCC7_SC may include a first electrode connected to the eleventh signal generating node GN11_SC and a second electrode connected to the boosting control node BCRN_SC.

The first gate signal output control block 340 may include first to fifth output transistors CT1_SC, CT2_SC, CT3_SC, CT4_SC and CT5_SC.

The first output transistor CT1_SC may include a control electrode receiving the previous first carry signal CR[n−1]_SC, a first electrode receiving the first high voltage VGH1 and a second electrode connected to a first electrode of the second output transistor CT2_SC. The second output transistor CT2_SC may include a control electrode receiving the previous first carry signal CR[n−1]_SC, the first electrode connected to the second electrode of the first output transistor CT1_SC and a second electrode connected to the first output node OVN_SC. The first output transistor CT1_SC and the second output transistor CT2_SC may be connected in series. In an embodiment, the first output transistor CT1_SC and the second output transistor CT2_SC may be configured as a single transistor. In response to the previous first carry signal CR[n−1]_SC, the first output transistor CT1_SC and the second output transistor CT2_SC may be turned on. When the first output transistor CT1_SC and the second output transistor CT2_SC are turned on, the first high voltage VGH1 may be applied to the first output node OVN_SC. When the first high voltage VGH1 is applied to the first output node OVN_SC, the first output control voltage OV_SC may have the first high voltage VGH1.

The third output transistor CT3_SC may include a control electrode connected to the boosting control line BCRL_SC, a first electrode receiving the second high voltage VGH2 and a second electrode connected to the first output node OVN_SC. The third output transistor CT3_SC may apply the second high voltage VGH2 to the first output node OVN_SC in response to the boosting control signal BCR. When the second high voltage VGH2 is applied to the first output node OVN_SC, the first output control voltage OV_SC may have the second high voltage VGH2.

The fourth output transistor CT4_SC may include a control electrode receiving the first carry signal CR[n+1]_SC, a first electrode receiving the second high voltage VGH2 and a second electrode connected to the first output node OVN_SC. The fourth output transistor CT4_SC may apply the second high voltage VGH2 to the first output node OVN_SC in response to the first carry signal CR[n+1]_SC.

The fifth output transistor CT5_SC may include a control electrode receiving the second input signal S2, a first electrode receiving the output control signal OCS and a second electrode connected to the first output node OVN_SC. The fifth output transistor CT5_SC may apply the output control signal OCS to the first output node OVN_SC in response to the second input signal S2.

In the first period TP1A, the first input signal S1 may have an activation level, and the vertical start signal S5_SC may have an activation level. In an embodiment, the vertical start signal S5_SC may be a previous first carry signal CR[n−1]_SC.

In the first period TP1A, the seventh scan gate transistor T7_SC and the eighth scan gate transistor T8_SC may be turned on in response to the vertical start signal S5_SC. The seventh scan gate transistor T7_SC and the eighth scan gate transistor T8_SC may be turned on, so that the vertical start signal S5_SC having an activation level may be applied to the first common control node Q_SC. For example, a voltage of the activation level of the vertical start signal S5_SC may be a first high voltage VGH1. In the first period TP1A, the first common control node Q_SC may have the first high voltage VGH1. The thirteenth scan gate transistor T13_SC may be turned on in response to a voltage of the first common control node Q_SC. The thirteenth scan gate transistor T13_SC may be turned on, so that the first low voltage VGL1 may be applied to the first inverting control node QB_SC. In the first period TP1A, the first common control signal QCS_SC having the first high voltage VGH1 may be output to the first common control line QL_SC. The first signal generating transistor BT1_SC and the third signal generating transistor BT3_SC may be turned on in response to the first common control signal QCS_SC.

In the first period TP1A, the first output transistor CT1_SC and the second output transistor CT2_SC may be turned on in response to the vertical start signal S5_SC. The first output transistor CT1_SC and the second output transistor CT2_SC may be turned on, so that the first high voltage VGH1 may be applied to the first output node OVN_SC. Accordingly, the first output control voltage OV_SC may have the first high voltage VGH1. In response to the first output control voltage OV_SC, the sixth signal generating transistor BT6_SC, the ninth signal generating transistor BT9_SC, the twelfth signal generating transistor BT12_SC, the fifteenth signal generating transistor BT15_SC, the eighteenth signal generating transistor BT18_SC and a twenty-first signal generating transistor BT21_SC may be turned on. The sixth signal generating transistor BT6_SC, so that the ninth signal generating transistor BT9_SC, the twelfth signal generating transistor BT12_SC, the fifteenth signal generating transistor BT15_SC, the eighteenth signal generating transistor BT18_SC and the twenty-first signal generating transistor BT21_SC may be turned on, the fifth signal generating transistor BT5_SC, the eighth signal generating transistor BT8_SC, the eleventh signal generating transistor BT11_SC, the fourteenth signal generating transistor BT14_SC, the seventeenth signal generating transistor BT17_SC and the twentieth signal generating transistor BT20_SC may be turned on.

In the second period TP2A, the first stage boosting clock signal BCK1 may have an activation level. The first signal generating transistor BT1_SC may be turned on based on the first stage boosting clock signal BCK1 and the first common control signal QCS_SC having the first high voltage VGH1 of the first stage. Accordingly, the first stage boosting clock signal BCK1 may be applied to the boosting control node BCRN_SC. Accordingly, the boosting control signal BCR having an activation level may be output. In response to the boosting control signal BCR having an activation level, the third output transistor CT3_SC may be turned on. The third output transistor CT3_SC may be turned on, the second high voltage VGH2 lower than the first high voltage VGH1 may be output to the first output node OVN_SC. Accordingly, the first output control voltage OV_SC may have the second high voltage VGH2. Based on the first output control voltage OV_SC having the second high voltage VGH2 and the first common control signal QCS_SC having the first high voltage VGH1, the sixth signal generating transistor BT6_SC, the ninth signal generating transistor BT9_SC, the twelfth signal generating transistor BT12_SC, the fifteenth signal generating transistor BT15_SC, the eighteenth signal generating transistor BT18_SC and the twenty-first signal generating transistor BT21_SC may be turned off. The sixth signal generating transistor BT6_SC, the ninth signal generating transistor BT9_SC, the twelfth signal generating transistor BT12_SC, the fifteenth signal generating transistor BT15_SC, the eighteenth signal generating transistor BT18_SC and the twenty-first signal generating transistor BT21_SC may be turned off, so that the first signal generating node GN1_SC, the third signal generating node GN3_SC, the fifth signal generating node GN5_SC, the seventh signal generating node GN7_SC, the ninth signal generating node GN9_SC and the eleventh signal generating node GN11_SC may be floated.

In the second period TP2A, a voltages of the first signal generating node GN1_SC, the third signal generating node GN3_SC, the fifth signal generating node GN5_SC, the seventh signal generating node GN7_SC, the ninth signal generating node GN9_SC and the eleventh signal generating node GN11_SC may be boosted through a coupling of the first to seventh boosting capacitors BCC1_SC, BCC2_SC, BCC3_SC, BCC4_SC, BCC5_SC, BCC6_SC and BCC7_SC.

In the second period TP2A, the first to sixth scan clock signals SCCK[1], SCCK[2], SCCK[3], SCCK[4], SCCK[5] and SCCK[6] having an activation level may be output. For example, the first to sixth scan clock signals SCCK[1], SCCK[2], SCCK[3], SCCK[4], SCCK[5] and SCCK[6] may be sequentially output. Accordingly, the first to sixth scan clock signals SCCK[1], SCCK[2], SCCK[3], SCCK[4], SCCK[5] and SCCK[6] may be applied to each of the second signal generating node GN2_SC, the fourth signal generating node GN4_SC, the sixth signal generating node GN6_SC, the eighth signal generating node GN8_SC, the tenth signal generating node GN10_SC and the twelfth signal generating node GN12_SC. Accordingly, the second signal generating node GN2_SC, the fourth signal generating node GN4_SC, the sixth signal generating node GN6_SC, the eighth signal generating node GN8_SC, the tenth signal generating node GN10_SC and the twelfth signal generating node GN12_SC may output the first gate signals SC[1] to SC[k].

In the second period TP2A, the first stage boosting clock signal BCK1 may change from an activation level to an inactivation level. Accordingly, the boosting clock signal BCK1 having the inactivated level may be applied to the boosting control node BCRN_SC. Based on a voltage change of the boosting control node BCRN_SC, the first signal generating node GN1_SC, the third signal generating node GN3_SC, the fifth signal generating node GN5_SC, the seventh signal generating node GN7_SC, the ninth signal generating node GN9_SC and the eleventh signal generating node GN11_SC may be coupled. Accordingly, voltages of the first signal generating node GN1_SC, the third signal generating node GN3_SC, the fifth signal generating node GN5_SC, the seventh signal generating node GN7_SC, the ninth signal generating node GN9_SC and the eleventh signal generating node GN11_SC may be lowered by a voltage change of the boosting control node BCRN_SC. Additionally, the next carry signal CR[n+1]_SC may have an activation level, so that the first low voltage VGL1 may be applied to the first common control node Q_SC. Accordingly, the fifth signal generating transistor BT5_SC, the eighth signal generating transistor BT8_SC, the eleventh signal generating transistor BT11_SC, the fourteenth signal generating transistor BT14_SC, the seventeenth signal generating transistor BT17_SC and the twentieth signal generating transistor BT20_SC may be turned off.

In the second period TP2A, the second stage boosting clock signal BCK2 may have an activation level. Based on the second stage boosting clock signal BCK2 and the first common control signal QCS_SC of the second stage, the first gate signals SC[7] to SC[12] of the second stage may be output. For example, based on the first common control signal QCS_SC of the second stage, the first gate signals SC[7] to SC[12] of the second stage may be sequentially output.

In the second period TP2A, the first carry clock signal CR_CK_SC2 of the second stage may have an activation level. When the first carry clock signal CR_CK_SC2 of the second stage has an activation level, the next carry signal CR[n+1]_SC may have an activation level. Accordingly, the third scan gate transistor T3_SC and the fourth scan gate transistor T4_SC may be turned on. The third scan gate transistor T3_SC and the fourth scan gate transistor T4_SC may be turned on, so that the first low voltage VGL1 may be applied to the first common control node Q_SC. Accordingly, the first common control node Q_SC may be initialized to the first low voltage VGL1. The first common control node Q_SC may have the first low voltage VGL1, the twelfth scan gate transistor T12_SC and the thirteenth scan gate transistor T13_SC may be turned off. The tenth scan gate transistor T10_SC and the eleventh scan gate transistor T11_SC may be turned on. The tenth scan gate transistor T10_SC and the eleventh scan gate transistor T11_SC may be turned on, and the twelfth scan gate transistor T12_SC and the thirteenth scan gate transistor T13_SC may be turned off, so that the second scan node SCN2 may have the second high voltage VGH2. The second scan node SCN2 may have the second high voltage VGH2, so that the second high voltage VGH2 may be applied to the first inverting common control node QB_SC. The second high voltage VGH2 may be applied to the first inverting common control node QB_SC, the second signal generating transistor BT2_SC, the fourth signal generating transistor BT4_SC, the seventh signal generating transistor BT7_SC, the tenth signal generating transistor BT10_SC, the thirteenth signal generating transistor BT13_SC, the sixteenth signal generating transistor BT16_SC, the nineteenth signal generating transistor BT19_SC and the twenty-second signal generating transistor BT22_SC may be turned on. Accordingly, the first low voltage VGL1 may be applied to the boosting control node BCRN_SC. Additionally, the second low voltage VGL2 may be applied to the second signal generating node GN2_SC, the fourth signal generating node GN4_SC, the sixth signal generating node GN6_SC, the eighth signal generating node GN8_SC, the tenth signal generating node GN10_SC, and the twelfth signal generating node GN12_SC. Additionally, the next carry signal CR[n+1]_SC may have an activation level, so that the second high voltage VGH2 may be applied to the first output node OVN_SC. Accordingly, the first output control voltage OV_SC may have the second high voltage VGH2.

In the third period TP3A, the second input signal S2 may have an activation level. Accordingly, the first output control node OCN1 may be initialized. For example, the first output control node OCN1 may be initialized with a voltage of the first common control node Q_SC.

In the fourth period TP4A, the first input signal S1 and the first reset signal RST_SC may have activation levels. In the fourth period TP4A, the first output control transistor CT1_SC and the second output control transistor CT2_SC may be turned on in response to the first input signal S1. In the fourth period TP4A, the boosting control signal BCR may have the first low voltage VGL1. Accordingly, the second output control node OCN2 may be initialized to the first low voltage VGL1. Additionally, the first scan gate transistor T1_SC and the second scan gate transistor T2_SC may be turned on in response to the first reset signal RST_SC. The first scan gate transistor T1_SC and the second scan gate transistor T2_SC may be turned on, so that the first low voltage VGL1 may be applied to the first common control node Q_SC.

Referring to FIG. 5A, the control signal generating block 310 may further include first to seventeenth sensing gate transistors T1_SS, T2_SS, T3_SS, T4_SS, T5_SS, T6_SS, T7_SS, T8_SS, T9_SS, T10_SS, T11_SS, T12_SS, T13_SS, T14_SS, T15_SS, T16_SS and T17_SS.

The first sensing gate transistor T1_SS may include a control electrode receiving the second reset signal RST_SS, a first electrode connected to a first sensing node SSN1, and a second electrode receiving the first low voltage VGL1. The first sensing gate transistor T1_SS may apply the first low voltage VGL1 to the first sensing node SSN1 in response to the second reset signal RST_SS. For example, the first sensing gate transistor T1_SS may initialize the first sensing node SSN1 to the first low voltage VGL1 in response to the second reset signal RST_SS.

The second sensing gate transistor T2_SS may include a control electrode receiving the second reset signal RST_SS, a first electrode connected to the second common control node Q_SS and a second electrode connected to the first sensing node SSN1. The second sensing gate transistor T2_SS may connect the second common control node Q_SS and the first sensing node SSN1 in response to the second reset signal RST_SS. Accordingly, the second common control node Q_SS may be initialized to the first low voltage VGL1 in response to the second reset signal RST_SS.

The third sensing gate transistor T3_SS may include a control electrode receiving the second carry signal CR[n+1]_SS, a first electrode connected to the first sensing node SSN1 and a second electrode receiving the first low voltage VGL1. The third sensing gate transistor T3_SS may apply the first low voltage VGL1 to the first sensing node SSN1 in response to the second carry signal CR[n+1]_SS. For example, the third sensing gate transistor T3_SS may initialize the first sensing node SSN1 to the first low voltage VGL1 in response to the second carry signal CR[n+1]_SS.

The fourth sensing gate transistor T4_SS may include a control electrode receiving the second carry signal CR[n+1]_SS, a first electrode connected to the second common control node Q_SS and a second electrode connected to the first sensing node SSN1. The fourth sensing gate transistor T4_SS may connect the second common control node Q_SS and the first sensing node SSN1 in response to the second carry signal CR[n+1]_SS. Accordingly, the second common control node Q_SS may be initialized to the first low voltage VGL1 in response to the second carry signal CR[n+1]_SS.

The fifth sensing gate transistor T5_SS may include a control electrode connected to the second inverting common control node QB_SS, a first electrode connected to the first sensing node SSN1 and a second electrode receiving the first low voltage VGL1. The fifth sensing gate transistor T5_SS may apply the first low voltage VGL1 to the first sensing node SSN1 in response to a voltage of the second inverting common control node QB_SS.

The sixth sensing gate transistor T6_SS may include a control electrode connected to the second inverting common control node QB_SS, a first electrode connected to the second common control node Q_SS and a second electrode connected to the first sensing node SSN1. The sixth sensing gate transistor T6_SS may connect the second common control node Q_SS and the first sensing node SSN1 in response to a voltage of the second inverting common control node QB_SS. The second inverting common control node QB_SS may be connected to the second inverting common control line QBL_SS.

The seventh sensing gate transistor T7_SS may include a control electrode receiving the previous second carry signal CR[n−1]_SS, a first electrode receiving the previous second carry signal CR[n−1]_SS and a second electrode connected to the first sensing node SSN1.

The eighth sensing gate transistor T8_SS may include a control electrode receiving the previous second carry signal CR[n−1]_SS, a first electrode connected to the first sensing node SSN1 and a second electrode connected to the second common control node Q_SS. The eighth sensing gate transistor T8_SS may connect the first sensing node SSN1 and the second common control node Q_SS in response to the previous second carry signal CR[n−1]_SS. The second common control node Q_SS may be connected to the second common control line QL_SS.

The ninth sensing gate transistor T9_SS may include a control electrode connected to the second sensing node SSN2, a first electrode receiving the second high voltage VGH2 and a second electrode connected to a first electrode of the thirteenth sensing gate transistor T13_SS.

The tenth sensing gate transistor T10_SS may include a control electrode receiving the second high voltage VGH2, a first electrode receiving the second high voltage VGH2 and a second electrode connected to a first electrode of the eleventh sensing gate transistor T11_SS. The eleventh sensing gate transistor T11_SS may include a control electrode receiving the second high voltage VGH2, the first electrode connected to the second electrode of the tenth sensing gate transistor T10_SS and a second electrode connected to a second sensing node SSN2. The tenth sensing gate transistor T10_SS and the eleventh sensing gate transistor T11_SS may be connected in series. In an embodiment, the tenth sensing gate transistor T10_SS and the eleventh sensing gate transistor T11_SS may be configured as a single transistor.

The twelfth sensing gate transistor T12_SS may include a control electrode connected to the second common control node Q_SS, a first electrode connected to a second sensing node SSN2 and a second electrode receiving the second low voltage VGL2.

The thirteenth sensing gate transistor T13_SS may include a control electrode connected to the second common control node Q_SS, the first electrode connected to the second electrode of the ninth sensing gate transistor T9_SS and a second electrode receiving the first low voltage VGL1.

The fourteenth sensing gate transistor T14_SS may include a control electrode receiving the second input signal S2, a first electrode connected to a second electrode of the fifteenth sensing gate transistor T15_SS and a second electrode receiving the first low voltage VGL1.

The fifteenth sensing gate transistor T15_SS may include a control electrode receiving the boosting control signal BCR, a first electrode connected to the second inverting common control node QB_SS and a second electrode connected to the first electrode of the fourteenth sensing gate transistor T14_SS.

The sixteenth sensing gate transistor T16_SS may include a control electrode connected to the second common control node Q_SS, a first electrode receiving the first high voltage VGH1 and a second electrode connected to the first electrode of the seventeenth sensing gate transistor T17_SS. The seventeenth sensing gate transistor T17_SS may include a control electrode connected to the second common control node Q_SS, a first electrode connected to the second electrode of the sixteenth sensing gate transistor T16_SS and a second electrode connected to the first sensing node SSN1. Accordingly, the first high voltage VGH1 may be applied to the first sensing node SSN1 in response to a voltage of the second common control node Q_SS. The sixteenth sensing gate transistor T16_SS and the seventeenth sensing gate transistor T17_SS may be connected in series. In an embodiment, the sixteenth sensing gate transistor T16_SS and the seventeenth sensing gate transistor T17_SS may be configured as a single transistor.

In the present embodiment, the second common control node Q_SS may output the second common control signal QCS_SS. The second common control signal QCS_SS may be applied to the second common control line QL_SS.

The output control signal generating block 320 may include the first to fifth output control transistors OCT1, OCT2, OCT3, OCT4 and OCT5 and the output control capacitor OCC.

Referring to FIG. 5C, the first gate signal output control block 340 may include the first to fifth output transistors CT1_SC, CT2_SC, CT3_SC, CT4_SC and CT5_SC.

The first output transistor CT1_SC may include a control electrode receiving the previous first carry signal CR[n−1]_SC, a first electrode receiving the first high voltage VGH1 and a second electrode connected to the first electrode of the second output transistor CT2_SC. The second output transistor CT2_SC may include a control electrode receiving the previous first carry signal CR[n−1]_SC, a first electrode connected to the second electrode of the first output transistor CT1_SC and a second electrode connected to the first output node OVN_SC. The first output transistor CT1_SC and the second output transistor CT2_SC may be connected in series. In an embodiment, the first output transistor CT1_SC and the second output transistor CT2_SC may be configured as a single transistor. In response to the previous first carry signal CR[n−1]_SC, the first output transistor CT1_SC and the second output transistor CT2_SC may be turned on. When the first output transistor CT1_SC and the second output transistor CT2_SC are turned on, the first high voltage VGH1 may be applied to the first output node OVN_SC. When the first high voltage VGH1 is applied to the first output node OVN_SC, the first output control voltage OV_SC may have the first high voltage VGH1.

The third output transistor CT3_SC may include a control electrode connected to the boosting control line BCRL_SC, a first electrode receiving the second high voltage VGH2 and a second electrode connected to the first output node OVN_SC. The third output transistor CT3_SC may apply the second high voltage VGH2 to the first output node OVN_SC in response to the boosting control signal BCR. When the second high voltage VGH2 is applied to the first output node OVN_SC, the first output control voltage OV_SC may have the second high voltage VGH2.

The fourth output transistor CT4_SC may include a control electrode receiving the first carry signal CR[n+1]_SC, a first electrode receiving the second high voltage VGH2 and a second electrode connected to the first output node OVN_SC. The fourth output transistor CT4_SC may apply the second high voltage VGH2 to the first output node OVN_SC in response to the first carry signal CR[n+1]_SC.

The fifth output transistor CT5_SC may include a control electrode receiving the second input signal S2, a first electrode receiving the output control signal OCS and a second electrode connected to the first output node OVN_SC. The fifth output transistor CT5_SC may apply the output control signal OCS to the first output node OVN_SC in response to the second input signal S2.

The second gate signal generating control block 350 may include first to twenty-second signal generating transistors BT1_SS, BT2_SS, BT3_SS, BT4_SS, BT5_SS, BT6_SS, BT7_SS, BT8_SS, BT9_SS, BT10_SS, BT11_SS, BT12_SS, BT13_SS, BT14_SS, BT15_SS, BT16_SS, BT17_SS, BT18_SS, BT19_SS, BT20_SS, BT21_SS and BT22_SS and first to seventh boosting capacitors BCC1_SS, BCC2_SS, BCC3_SS, BCC4_SS, BCC5_SS, BCC6_SS and BCC7_SS.

The first signal generating transistor BT1_SS may include a control electrode connected to the second common control line QL_SS, a first electrode receiving the boosting clock signal BCK and a second electrode connected to the boosting control node BCRN_SS. The first signal generating transistor BT1_SS may apply the boosting clock signal BCK to the boosting control node BCRN_SS in response to the second common control signal QCS_SS. The boosting control node BCRN_SS may be connected to the boosting control line BCRL_SC.

The second signal generating transistor BT2_SS may include a control electrode connected to the second inverting common control line QBL_SS, a first electrode connected to the boosting control node BCRN_SS and a second electrode receiving the first low voltage VGL1. The second signal generating transistor BT2_SS may apply the first low voltage VGL1 to the boosting control node BCRN_SS in response to a voltage of the first inverting common control node QB_SC.

The third signal generating transistor BT3_SS may include a control electrode connected to the second common control line QL_SS, a first electrode receiving the second carry clock signal CRCK_SS and a second electrode connected to the second carry output node CON1_SS. The second carry output node CON1_SS may output the second carry signal CR[n]_SS.

The fourth signal generating transistor BT4_SS may include a control electrode connected to the second inverting common control line QBL_SS, a first electrode connected to the second carry output node CON1_SS and a second electrode receiving the second low voltage VGL2. The fourth signal generating transistor BT4_SS may apply the second low voltage VGL2 to the second carry output node CON1_SS in response to a voltage of the second inverting common control node QB_SS.

The fifth signal generating transistor BT5_SS may include a control electrode connected to a first signal generating node GN1_SS, a first electrode receiving the first sensing clock signal SSCK[1] and a second electrode connected to a second signal generating node GN2_SS. The fifth signal generating transistor BT5_SS may apply the first sensing clock signal SSCK[1] to the second signal generating node GN2_SS in response to a voltage of the first signal generating node GN1_SS. The second signal generating node GN2_SS may output a first sensing gate signal SS[1].

The sixth signal generating transistor BT6_SS may include a control electrode receiving the second output control voltage OV_SS, a first electrode connected to the second common control line QL_SS and a second electrode connected to the first signal generating node GN1_SS. The sixth signal generating transistor BT6_SS may apply the second common control signal QCS_SS to the first signal generating node GN1_SS in response to the second output control voltage OV_SS. When the second output control voltage OV_SS has the first high voltage VGH1, the sixth signal generating transistor BT6_SS may be turned on. The sixth signal generating transistor BT6_SS may be turned on, so that the second common control signal QCS_SS may be applied to the first signal generating node GN1_SS. The second common control signal QCS_SS may be applied to the first signal generating node GN1_SS, the fifth signal generating transistor BT5_SS may be turned on. Accordingly, the first sensing clock signal SSCK[1] may be applied to the second signal generating node GN2_SS. Accordingly, the first sensing gate signal SS[1] corresponding to the first sensing clock signal SSCK[1] may be output. When the second output control voltage OV_SS has the second high voltage VGH2, the sixth signal generating transistor BT6_SS may be turned off.

The seventh signal generating transistor BT7_SS may include a control electrode connected to the second inverting common control line QBL_SS, a first electrode connected to the second signal generating node GN2_SS and a second electrode receiving the second low voltage VGL2. The seventh signal generating transistor BT7_SS may apply the second low voltage VGL2 to the second signal generating node GN2_SS in response to a voltage of the second inverting common control node QB_SS.

The eighth signal generating transistor BT8_SS may include a control electrode connected to a third signal generating node GN3_SS, a first electrode receiving a second sensing clock signal SSCK[2] and a second electrode connected to a fourth signal generating node GN4_SS. The eighth signal generating transistor BT8_SS may apply the second sensing clock signal SSCK[2] to the fourth signal generating node GN4_SS in response to a voltage of the third signal generating node GN3_SS. The fourth signal generating node GN4_SS may output a second sensing gate signal SS[2].

The ninth signal generating transistor BT9_SS may include a control electrode receiving the second output control voltage OV_SS, a first electrode connected to the second common control line QL_SS and a second electrode connected to a third signal generating node GN3_SS. The ninth signal generating transistor BT9_SS may apply the second common control signal QCS_SS to the third signal generating node GN3_SS in response to the second output control voltage OV_SS. When the second output control voltage OV_SS has the first high voltage VGH1, the ninth signal generating transistor BT9_SS may be turned on. The ninth signal generating transistor BT9_SS may be turned on, so that the second common control signal QCS_SS may be applied to the third signal generating node GN3_SS. The second common control signal QCS_SS may be applied to the third signal generating node GN3_SS, the eighth signal generating transistor BT8_SS may be turned on. Accordingly, the second sensing clock signal SSCK[2] may be applied to the fourth signal generating node GN4_SS. Accordingly, the second sensing gate signal SS[2] corresponding to the second sensing clock signal SSCK[2] may be output. When the second output control voltage OV_SS has the second high voltage VGH2, the ninth signal generating transistor BT9_SS may be turned off.

The tenth signal generating transistor BT10_SS may include a control electrode connected to the second inverting common control line QBL_SS, a first electrode connected to the fourth signal generating node GN4_SS and a second electrode receiving the second low voltage VGL2. The tenth signal generating transistor BT10_SS may apply the second low voltage VGL2 to the fourth signal generating node GN4_SS in response to a voltage of the second inverting common control node QB_SS.

The eleventh signal generating transistor BT11_SS may include a control electrode connected to the fifth signal generating node GN5_SS, a first electrode receiving a third sensing clock signal SSCK[3] and a second electrode connected to the sixth signal generating node GN6_SS. The eleventh signal generating transistor BT11_SS may apply the third sensing clock signal SSCK[3] to the sixth signal generating node GN6_SS in response to a voltage of the fifth signal generating node GN5_SS. The sixth signal generating node GN6_SS may output the third sensing gate signal SS[3].

The twelfth signal generating transistor BT12_SS may include a control electrode receiving the second output control voltage OV_SS, a first electrode connected to the second common control line QL_SS and a second electrode connected to a fifth signal generating node GN5_SS. The twelfth signal generating transistor BT12_SS may apply the second common control signal QCS_SS to the fifth signal generating node GN5_SS in response to the second output control voltage OV_SS. When the second output control voltage OV_SS has the first high voltage VGH1, the twelfth signal generating transistor BT12_SS may be turned on. The twelfth signal generating transistor BT12_SS may be turned on, so that the second common control signal QCS_SS may be applied to the fifth signal generating node GN5_SS. The second common control signal QCS_SS may be applied to the fifth signal generating node GN5_SS, the eleventh signal generating transistor BT11_SS may be turned on. Accordingly, the third sensing clock signal SSCK[3] may be applied to the sixth signal generating node GN6_SS. Accordingly, the third sensing gate signal SS[3] corresponding to the third sensing clock signal SSCK[3] may be output. When the second output control voltage OV_SS has the second high voltage VGH2, the twelfth signal generating transistor BT12_SS may be turned off.

The thirteenth signal generating transistor BT13_SS may include a control electrode connected to the second inverting common control line QBL_SS, a first electrode connected to the sixth signal generating node GN6_SS and a second electrode receiving the second low voltage VGL2. The thirteenth signal generating transistor BT13_SS may apply the second low voltage VGL2 to the sixth signal generating node GN6_SS in response to a voltage of the second inverting common control node QB_SS.

The fourteenth signal generating transistor BT14_SS may include a control electrode connected to the seventh signal generating node GN7_SS, a first electrode receiving a fourth sensing clock signal SSCK[4] and a second electrode connected to the eighth signal generating node GN8_SS. The fourteenth signal generating transistor BT14_SS may apply the fourth sensing clock signal SSCK[4] to the eighth signal generating node GN8_SS in response to a voltage of the seventh signal generating node GN7_SS. The eighth signal generating node GN8_SS may output the fourth sensing gate signal SS[4].

The fifteenth signal generating transistor BT15_SS may include a control electrode receiving the second output control voltage OV_SS, a first electrode connected to the second common control line QL_SS and a second electrode connected to a seventh signal generating node GN7_SS. The fifteenth signal generating transistor BT15_SS may apply the second common control signal QCS_SS to the seventh signal generating node GN7_SS in response to the second output control voltage OV_SS. When the second output control voltage OV_SS has the first high voltage VGH1, the fifteenth signal generating transistor BT15_SS may be turned on. The fifteenth signal generating transistor BT15_SS may be turned on, the second common control signal QCS_SS may be applied to the seventh signal generating node GN7_SS. The second common control signal QCS_SS may be applied to the seventh signal generating node GN7_SS, the fourteenth signal generating transistor BT14_SS may be turned on. Accordingly, the fourth sensing clock signal SSCK[4] may be applied to the eighth signal generating node GN8_SS. Accordingly, the fourth sensing gate signal SS[4] corresponding to the fourth sensing clock signal SSCK[4] may be output. When the second output control voltage OV_SS has the second high voltage VGH2, the fifteenth signal generating transistor BT15_SS may be turned off.

The sixteenth signal generating transistor BT16_SS may include a control electrode connected to the second inverting common control line QBL_SS, a first electrode connected to the eighth signal generating node GN8_SS and a second electrode receiving the second low voltage VGL2. The sixteenth signal generating transistor BT16_SS may apply the second low voltage VGL2 to the eighth signal generating node GN8_SS in response to the voltage of the second inverting common control node QB_SS.

The seventeenth signal generating transistor BT17_SS may include a control electrode connected to a ninth signal generating node GN9_SS, a first electrode receiving a fifth sensing clock signal SSCK[5] and a second electrode connected to a tenth signal generating node GN10_SS. The seventeenth signal generating transistor BT17_SS may apply the fifth sensing clock signal SSCK[5] to the tenth signal generating node GN10_SS in response to a voltage of the ninth signal generating node GN9_SS. The tenth signal generating node GN10_SS may output the fifth sensing gate signal SS[5].

The eighteenth signal generating transistor BT18_SS may include a control electrode receiving the second output control voltage OV_SS, a first electrode connected to the second common control line QL_SS and a second electrode connected to the ninth signal generating node GN9_SS. The eighteenth signal generating transistor BT18_SS may apply the second common control signal QCS_SS to the ninth signal generating node GN9_SS in response to the second output control voltage OV_SS. When the second output control voltage OV_SS has the first high voltage VGH1, the eighteenth signal generating transistor BT18_SS may be turned on. The eighteenth signal generating transistor BT18_SS may be turned on, so that the second common control signal QCS_SS may be applied to the ninth signal generating node GN9_SS. The second common control signal QCS_SS may be applied to the ninth signal generating node GN9_SS, so that the seventeenth signal generating transistor BT17_SS may be turned on. Accordingly, the fifth sensing clock signal SSCK[5] may be applied to the tenth signal generating node GN10_SS. Accordingly, the fifth sensing gate signal SS[5] corresponding to the fifth sensing clock signal SSCK[5] may be output. When the second output control voltage OV_SS has the second high voltage VGH2, the eighteenth signal generating transistor BT18_SS may be turned off.

The nineteenth signal generating transistor BT19_SS may include a control electrode connected to the second inverting common control line QBL_SS, a first electrode connected to the tenth signal generating node GN10_SS, and a second electrode receiving the second low voltage VGL2. The nineteenth signal generating transistor BT19_SS may apply the second low voltage VGL2 to the tenth signal generating node GN10_SS in response to a voltage of the second inverting common control node QB_SS.

The twentieth signal generating transistor BT20_SS may include a control electrode connected to the eleventh signal generating node GN11_SS, a first electrode receiving a sixth sensing clock signal SSCK[6] and a second electrode connected to the twelfth signal generating node GN12_SS. The twentieth signal generating transistor BT20_SS may apply the sixth sensing clock signal SSCK[6] to the twelfth signal generating node GN12_SS in response to the voltage of the eleventh signal generating node GN11_SS. The twelfth signal generating node GN12_SS may output the sixth sensing gate signal SS[6].

The twenty-first signal generating transistor BT21_SS may include a control electrode receiving the second output control voltage OV_SS, a first electrode connected to the second common control line QL_SS and a second electrode connected to an eleventh signal generating node GN11_SS. The twenty-first signal generating transistor BT21_SS may apply the second common control signal QCS_SS to the eleventh signal generating node GN11_SS in response to the second output control voltage OV_SS. When the second output control voltage OV_SS has the first high voltage VGH1, the twenty-first signal generating transistor BT21_SS may be turned on. The twenty-first signal generating transistor BT21_SS may be turned on, so that the second common control signal QCS_SS may be applied to the eleventh signal generating node GN11_SS. The second common control signal QCS_SS may be applied to the eleventh signal generating node GN11_SS, the twentieth signal generating transistor BT20_SS may be turned on. Accordingly, the sixth sensing clock signal SSCK[6] may be applied to the twelfth signal generating node GN12_SS. Accordingly, the sixth sensing gate signal SS[6] corresponding to the sixth sensing clock signal SSCK[6] may be output. When the second output control voltage OV_SS has the second high voltage VGH2, the twenty-first signal generating transistor BT21_SS may be turned off.

The twenty-second signal generating transistor BT22_SS may include a control electrode connected to the second inverting common control line QBL_SS, a first electrode connected to the twelfth signal generating node GN12_SS and a second electrode receiving the second low voltage VGL2. The twenty-second signal generating transistor BT22_SS may apply the second low voltage VGL2 to the twelfth signal generating node GN12_SS in response to a voltage of the second inverting common control node QB_SS.

The first boosting capacitor BCC1_SS may include a first electrode connected to the second common control node Q_SS and a second electrode connected to the boosting control node BCRN_SS. The second boosting capacitor BCC2_SS may include a first electrode connected to the first signal generating node GN1_SS and a second electrode connected to the boosting control node BCRN_SS. The third boosting capacitor BCC3_SS may include a first electrode connected to the third signal generating node GN3_SS and a second electrode connected to the boosting control node BCRN_SS. The fourth boosting capacitor BCC4_SS may include a first electrode connected to the fifth signal generating node GN5_SS and a second electrode connected to the boosting control node BCRN_SS. The fifth boosting capacitor BCC5_SS may include a first electrode connected to the seventh signal generating node GN7_SS and a second electrode connected to the boosting control node BCRN_SS. The sixth boosting capacitor BCC6_SC may include a first electrode connected to the ninth signal generating node GN9_SS and a second electrode connected to the boosting control node BCRN_SS. The seventh boosting capacitor BCC7_SS may include a first electrode connected to the eleventh signal generating node GN11_SS and a second electrode connected to the boosting control node BCRN_SS.

Referring to FIG. 5E, the second gate signal output control block 360 may include first to fifth output transistors CT1_SS, CT2_SS, CT3_SS, CT4_SS and CT5_SS.

The first output transistor CT1_SS may include a control electrode receiving the previous second carry signal CR[n−1]_SS, a first electrode receiving the first high voltage VGH1 and a second electrode connected to a first electrode of the second output transistor CT1_SS. The second output transistor CT1_SS may include a control electrode receiving the previous second carry signal CR[n−1]_SS, the first electrode connected to the second electrode of the first output transistor CT1_SS and a second electrode connected to the first output node OVN_SS. The first output transistor CT1_SS and the second output transistor CT2_SS may be connected in series. In an embodiment, the first output transistor CT1_SS and the second output transistor CT2_SS may be configured as a single transistor. In response to the previous second carry signal CR[n−1]_SS, the first output transistor CT1_SS and the second output transistor CT2_SS may be turned on. When the first output transistor CT1_SS and the second output transistor CT2_SS are turned on, the first high voltage VGH1 may be applied to the first output node OVN_SS. When the first high voltage VGH1 is applied to the first output node OVN_SS, the second output control voltage OV_SS may have the first high voltage VGH1.

The third output transistor CT3_SS may include a control electrode connected to a boosting control line BCRL_SS, a first electrode receiving the second high voltage VGH2 and a second electrode connected to the first output node OVN_SS. The third output transistor CT3_SS may apply the second high voltage VGH2 to the first output node OVN_SS in response to the boosting control signal BCR. When the second high voltage VGH2 is applied to the first output node OVN_SS, the second output control voltage OV_SS may have the second high voltage VGH2.

The fourth output transistor CT4_SS may include a control electrode receiving the second carry signal CR[n+1]_SS, a first electrode receiving the second high voltage VGH2 and a second electrode connected to the first output node OVN_SS. The fourth output transistor CT4_SS may apply the second high voltage VGH2 to the first output node OVN_SS in response to the second carry signal CR[n+1]_SS.

The fifth output transistor CT5_SS may include a control electrode receiving the second input signal S2, a first electrode receiving the output control signal OCS and a second electrode connected to the first output node OVN_SS. The fifth output transistor CT5_SS may apply the output control signal OCS to the first output node OVN_SS in response to the second input signal S2.

In the first period TP1A, the first input signal S1 may have an activation level, and the vertical start signal S5_SS may have an activation level. In an embodiment, the vertical start signal S5_SS may be the previous second carry signal CR[n−1]_SS.

In the first period TP1A, the seventh sensing gate transistor T7_SS and the eighth sensing gate transistor T8_SS may be turned on in response to the vertical start signal S5_SS. The seventh sensing gate transistor T7_SS and the eighth sensing gate transistor T8_SS may be turned on, so that the vertical start signal S5_SS having an activation level may be applied to the second common control node Q_SS. For example, a voltage of the activation level of the vertical start signal S5_SS may be the first high voltage VGH1. In the first period TP1A, the second common control node Q_SS may have the first high voltage VGH1. The thirteenth sensing gate transistor T13_SS may be turned on in response to a voltage of the second common control node Q_SS. The thirteenth sensing gate transistor T13_SS may be turned on, so that the first low voltage VGL1 may be applied to the second inverting control node QB_SS. In the first period TP1A, the second common control signal QCS_SS having the first high voltage VGH1 may be output to the second common control line QL_SS. The first signal generating transistor BT1_SS and the third signal generating transistor BT3_SS may be turned on in response to the second common control signal QCS_SS.

In the first period TP1A, a first output transistor CT1_SS and a second output transistor CT2_SS may be turned on in response to the vertical start signal S5_SS. The first output transistor CT1_SS and the second output transistor CT2_SS may be turned on, so that the first high voltage VGH1 may be applied to the first output node OVN_SS. Accordingly, the first output control voltage OV_SS may have the first high voltage VGH1. In response to the first output control voltage OV_SS, the sixth signal generating transistor BT6_SS, the ninth signal generating transistor BT9_SS, the twelfth signal generating transistor BT12_SS, the fifteenth signal generating transistor BT15_SS, the eighteenth signal generating transistor BT18_SS and the twenty-first signal generating transistor BT21_SS may be turned on. The sixth signal generating transistor BT6_SS, the ninth signal generating transistor BT9_SS, the twelfth signal generating transistor BT12_SS, the fifteenth signal generating transistor BT15_SS, the eighteenth signal generating transistor BT18_SS and the twenty-first signal generating transistor BT21_SS may be turned on, so that the fifth signal generating transistor BT5_SS, the eighth signal generating transistor BT8_SS, the eleventh signal generating transistor BT11_SS, the fourteenth signal generating transistor BT14_SS, the seventeenth signal generating transistor BT17_SS and the twentieth signal generating transistor BT20_SS may be turned on.

In the second period TP2A, the first stage boosting clock signal BCK1 may have an activation level. The first signal generating transistor BT1_SS may be turned on based on the first stage boosting clock signal BCK1 and the second common control signal QCS_SS having the first high voltage VGH1 of the first stage. Accordingly, the first stage boosting clock signal BCK1 may be applied to the boosting control node BCRN_SS. In response to a voltage of the boosting control node BCRN_SS, the third output transistor CT3_SS may be turned on. The third output transistor CT3_SS may be turned on, so that the second high voltage VGH2 lower than the first high voltage VGH1 may be output to the first output node OVN_SS. Accordingly, the first output control voltage OV_SS may have the second high voltage VGH2. Based on the first output control voltage OV_SS having the second high voltage VGH2 and the second common control signal QCS_SS having the first high voltage VGH1, the sixth signal generating transistor BT6_SS, the ninth signal generating transistor BT9_SS, the twelfth signal generating transistor BT12_SS, the fifteenth signal generating transistor BT15_SS, the eighteenth signal generating transistor BT18_SS and the twenty-first signal generating transistor BT21_SS may be turned off. The sixth signal generating transistor BT6_SS, the ninth signal generating transistor BT9_SS, the twelfth signal generating transistor BT12_SS, the fifteenth signal generating transistor BT15_SS, the eighteenth signal generating transistor BT18_SS and the twenty-first signal generating transistor BT21_SS may be turned off, so that the first signal generating node GN1_SS, the third signal generating node GN3_SS, the fifth signal generating node GN5_SS, the seventh signal generating node GN7_SS, the ninth signal generating node GN9_SS and the eleventh signal generating node GN11_SS may be floated.

In the second period TP2A, voltages of the first signal generating node GN1_SS, the third signal generating node GN3_SS, the fifth signal generating node GN5_SS, the seventh signal generating node GN7_SS, the ninth signal generating node GN9_SS and the eleventh signal generating node GN11_SS may be boosted through a coupling of the first to seventh boosting capacitors BCC1_SS, BCC2_SS, BCC3_SS, BCC4_SS, BCC5_SS, BCC6_SS and BCC7_SS.

In the second period TP2A, the first to sixth sensing clock signals SSCK[1], SSCK[2], SSCK[3], SSCK[4], SSCK[5] and SSCK[6] having an activation level may be output. For example, the first to sixth scan clock signals SSCK[1], SSCK[2], SSCK[3], SSCK[4], SSCK[5] and SSCK[6]) may be sequentially output. Accordingly, the first to sixth sensing clock signals SSCK[1], SSCK[2], SSCK[3], SSCK[4], SSCK[5] and SSCK[6] may be applied to each of the second signal generating node GN2_SS, the fourth signal generating node GN4_SS, the sixth signal generating node GN6_SS, the eighth signal generating node GN8_SS, the tenth signal generating node GN10_SS and the twelfth signal generating node GN12_SS. Accordingly, the second signal generating node GN2_SS, the fourth signal generating node GN4_SS, the sixth signal generating node GN6_SS, the eighth signal generating node GN8_SS, the tenth signal generating node GN10_SS and the twelfth signal generating node GN12_SS may output second gate signals SS[1] to SS[k].

In the second period TP2A, the first stage boosting clock signal BCK1 may change from an activation level to an inactivation level. Accordingly, the boosting clock signal BCK1 having the inactivation level may be applied to the boosting control node BCRN_SS. Based on a voltage change of the boosting control node BCRN_SS, the first signal generating node GN1_SS, the third signal generating node GN3_SS, the fifth signal generating node GN5_SS, the seventh signal generating node GN7_SS, the ninth signal generating node GN9_SS and the eleventh signal generating node GN11_SS may be coupled. Accordingly, voltages of the first signal generating node GN1_SS, the third signal generating node GN3_SS, the fifth signal generating node GN5_SS, the seventh signal generating node GN7_SS, the ninth signal generating node GN9_SS and the eleventh signal generating node GN11_SS may be lowered by a voltage change of the boosting control node BCRN_SS. Additionally, the next carry signal CR[n+1]_SS may have an activation level, so that the first low voltage VGL1 may be applied to the second common control node Q_SS. Accordingly, the fifth signal generating transistor BT5_SS, the eighth signal generating transistor BT8_SS, the eleventh signal generating transistor BT11_SS, the fourteenth signal generating transistor BT14_SS, the seventeenth signal generating transistor BT17_SS and the twentieth signal generating transistor BT20_SS may be turned off.

In the second period TP2A, the second stage boosting clock signal BCK2 may have an activation level. The second gate signals SS[7] to SS[12] of the second stage may be output based on the second stage boosting clock signal BCK2 and the second common control signal QCS_SS of the second stage. For example, the second gate signals SS[7] to SS[12] of the second stage may be sequentially output based on the second common control signal QCS_SS of the second stage.

In the second period TP2A, the second carry clock signal CR_CK_SS2 of the second stage may have an activation level. When the second carry clock signal CR_CK_SS2 of the second stage has an activation level, the next carry signal CR[n+1]_SS may have an activation level. Accordingly, the third sensing gate transistor T3_SS and the fourth sensing gate transistor T4_SS may be turned on. The third sensing gate transistor T3_SS and the fourth sensing gate transistor T4_SS may be turned on, so that the first low voltage VGL1 may be applied to the second common control node Q_SS. Accordingly, the second common control node Q_SS may be initialized to the first low voltage VGL1. The second common control node Q_SS may have the first low voltage VGL1, so that the twelfth sensing gate transistor T12_SS and the thirteenth sensing gate transistor T13_SS may be turned off. The tenth sensing gate transistor T10_SS and the eleventh sensing gate transistor T11_SS may be turned on. The tenth sensing gate transistor T10_SS and the eleventh sensing gate transistor T11_SS may be turned on, and the twelfth sensing gate transistor T12_SS and the thirteenth sensing gate transistor T13_SS may be turned off, so that the second sensing node SSN2 may have the second high voltage VGH2. The second sensing node SSN2 may have the second high voltage VGH2, so that the second high voltage VGH2 may be applied to the second inverting common control node QB_SS. The second high voltage VGH2 may be applied to the second inverting common control node QB_SS, the second signal generating transistor BT2_SS, the fourth signal generating transistor BT4_SS, the seventh signal generating transistor BT7_SS, the tenth signal generating transistor BT10_SS, the thirteenth signal generating transistor BT13_SS, the sixteenth signal generating transistor BT16_SS, the nineteenth signal generating transistor BT19_SS and the twenty-second signal generating transistor BT22_SS may be turned on. Accordingly, the first low voltage VGL1 may be applied to the boosting control node BCRN_SS. Additionally, the second low voltage VGL2 may be applied to the second signal generating node GN2_SS, the fourth signal generating node GN4_SS, the sixth signal generating node GN6_SS, the eighth signal generating node GN8_SS, the tenth signal generating node GN10_SS and the twelfth signal generating node GN12_SS. Additionally, the next carry signal CR[n+1]_SS may have an activation level, so that the second high voltage VGH2 may be applied to the first output node OVN_SS. Accordingly, the first output control voltage OV_SS may have the second high voltage VGH2.

In the third period TP3A, the second input signal S2 may have an activation level. Accordingly, the first output control node OCN1 may be initialized. For example, the first output control node OCN1 may be initialized to a voltage of the second common control node Q_SS.

In the fourth period TP4A, the first input signal S1 and the second reset signal RST_SS may have activation levels. In the fourth period TP4A, the first output control transistor CT1_SS and the second output control transistor CT2_SS may be turned on in response to the first input signal S1. In the fourth period TP4A, the boosting control signal BCR may have the first low voltage VGL1. Accordingly, the second output control node OCN2 may be initialized to the first low voltage VGL1. Additionally, the first sensing gate transistor T1_SS and the second sensing gate transistor T2_SS may be turned on in response to the first reset signal RST_SS. The first sensing gate transistor T1_SS and the second sensing gate transistor T2_SS may be turned on, so that the first low voltage VGL1 may be applied to the second common control node Q_SS.

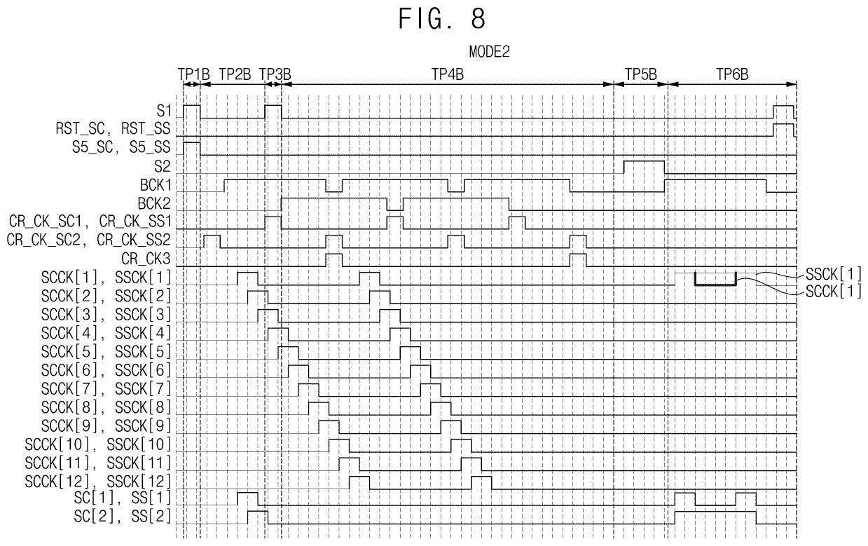

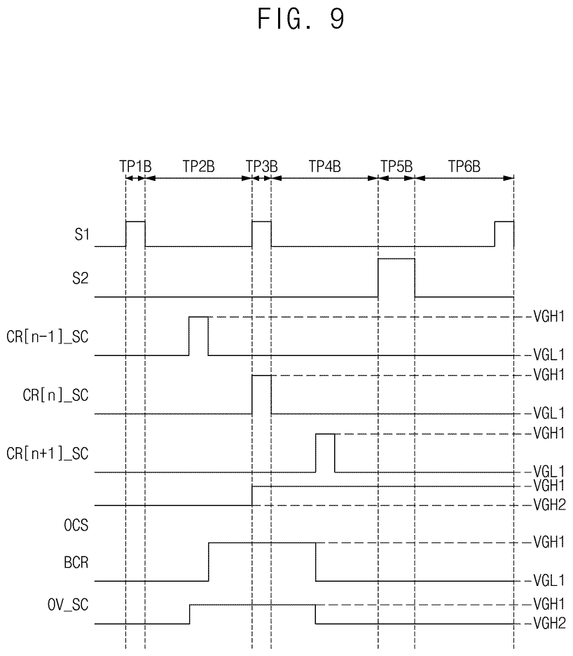

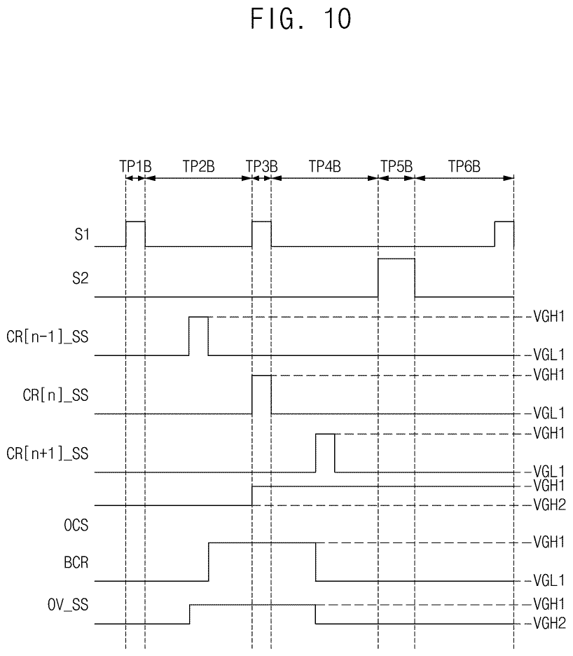

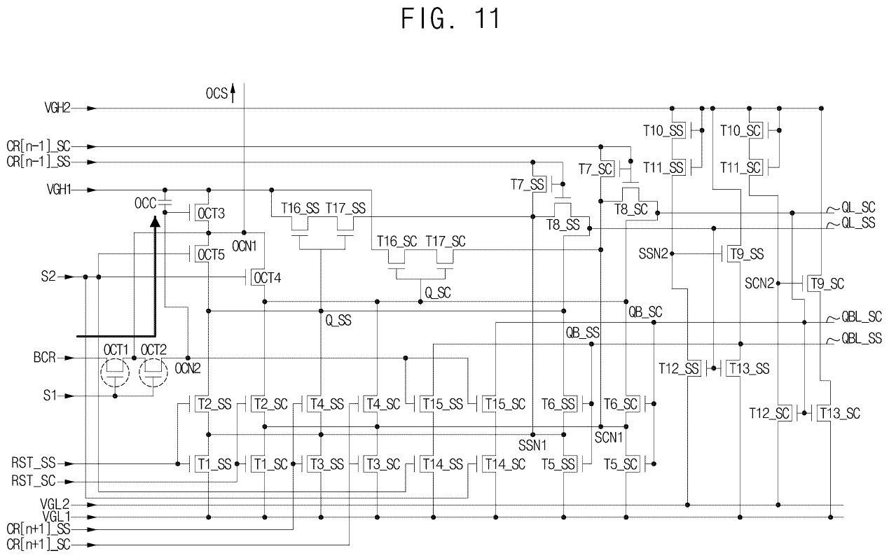

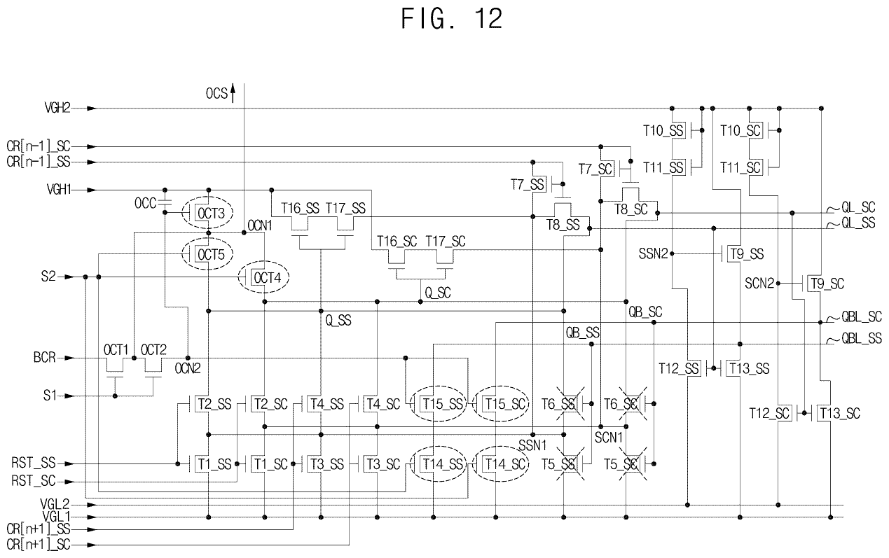

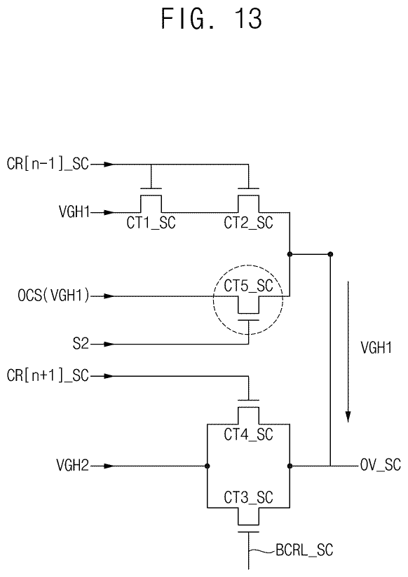

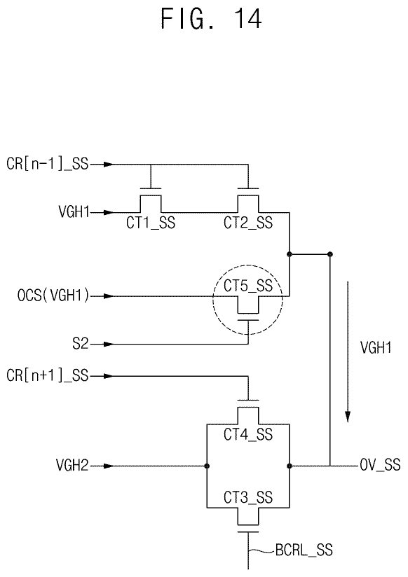

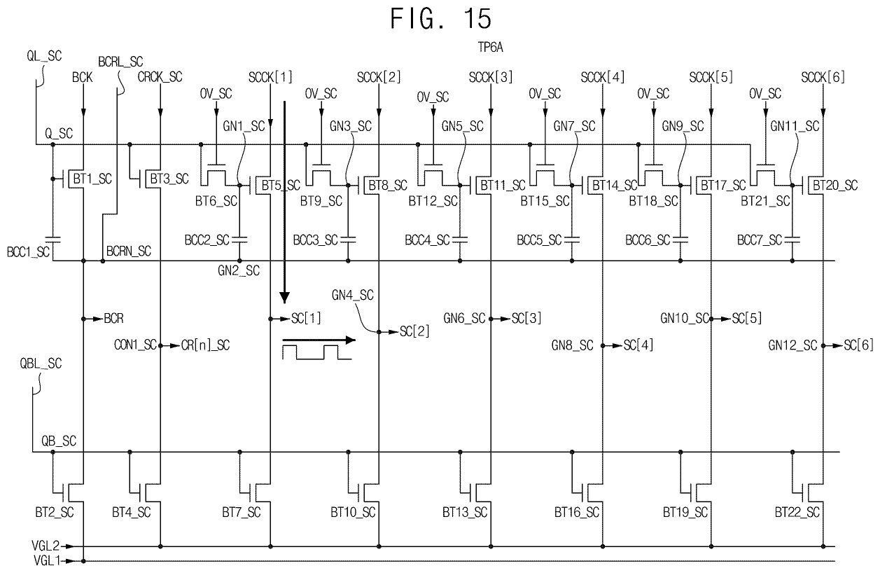

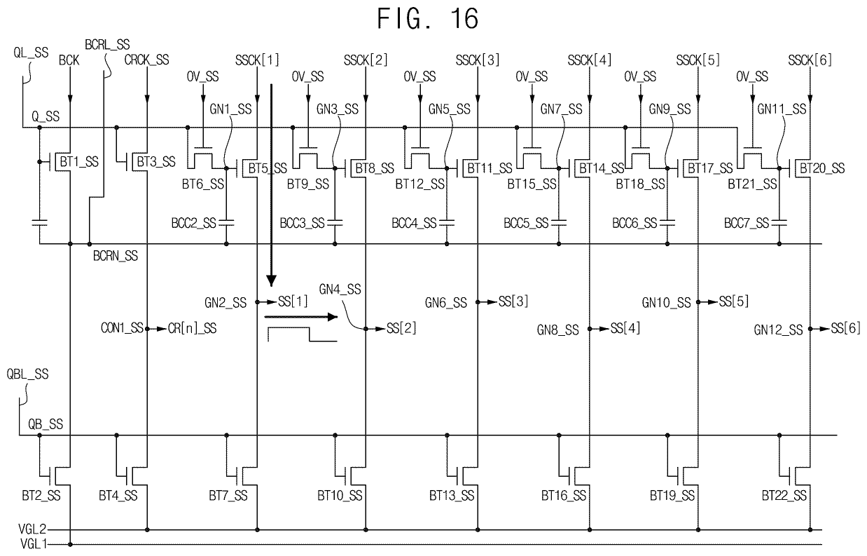

FIG. 8 is a timing diagram illustrating an example of signals applied to a gate driver 300 of FIG. 2. FIG. 9 is a timing diagram illustrating signals applied to a first gate signal output control block 340 of FIG. 5C. FIG. 10 is a timing diagram illustrating signals applied to a second gate signal output control block 360 of FIG. 5E. FIG. 11 is a circuit diagram illustrating of an operation of a control signal generating block 310 and an output control signal generating block 320 of FIG. 3 in a third period TP3B of FIG. 8. FIG. 12 is a circuit diagram illustrating of an operation of a control signal generating block 310 and an output control signal generating block 320 of FIG. 3 in a fifth period TP5B of FIG. 8. FIG. 13 is a circuit diagram illustrating an operation of a first gate signal output control block 340 of FIG. 3 in a fifth period TP5B of FIG. 8. FIG. 14 is a circuit diagram illustrating an operation of a second gate signal output control block 360 of FIG. 3 in a fifth period TP5B of FIG. 8. FIG. 15 is a circuit diagram illustrating an operation of a first gate signal control block 330 of FIG. 3 in a sixth period TP6B of FIG. 8. FIG. 16 is a circuit diagram illustrating an operation of a second gate signal control block 350 of FIG. 3 in a sixth period TP6B of FIG. 8.

Referring to FIG. 1 to FIG. 16, a frame period in which the gate driver 300 is driven may include first to sixth periods TP1B, TP2B, TP3B, TP4B, TP5B and TP6B. For example, a frame period in which the gate driver 300 is driven may include an active period in which gate signals are output and a blank period after the active period. In the present embodiment, the active period may include the first to fifth periods TP1B, TP2B, TP3B, TP4B and TP5B. The blank period may include the sixth period TP6B. For example, the driving of the gate driver 300 in a frame period including the first to sixth periods TP1B, TP2B, TP3B, TP4B, TP5B and TP6B may be called as a second driving MODE 2. For example, the second driving MODE 2 may be called as a sensing driving.

In the first period TP1B, the first input signal S1 may have an activation level, and the vertical start signals S5_SC, S5_SS may have an activation level.

In the first period TP1B, the seventh scan gate transistor T7_SC, the eighth scan gate transistor T8_SC, the seventh sensing gate transistor T7_SS and the eighth sensing gate transistor T8_SS may be turned on in response to the vertical start signals S5_SC, S5_SS. The seventh scan gate transistor T7_SC, the eighth scan gate transistor T8_SC, the seventh sensing gate transistor T7_SS and the eighth sensing gate transistor T8_SS may be turned on, so that the first common control signal QCS_SC and the second common control signal QCS_SS may be output.

In the second period TP2B, the first stage boosting clock signal BCK1 may have an activation level. The first gate signals SC[1] to SC[k] of the first stage may be output based on the first stage boosting clock signal BCK1 and the first common control signal QCS_SC of the first stage. For example, the first gate signals SC[1] to SC[k] of the first stage may be sequentially output based on the first common control signal QCS_SC of the first stage. The second gate signals SS[1] to SS[k] of the first stage may be output based on the first stage boosting clock signal BCK and the second common control signal QCS_SS of the first stage.

In the third period TP3B, the first input signal S1 may have an activation level. Additionally, in the third period TP3B, the first stage boosting clock signal BCK1 may have an activation level. In response to the first input signal S1, the first output control transistor OCT1 and the second output control transistor OCT2 may be turned on. The first output control transistor OCT1 and the second output control transistor OCT2 may be turned on, so that the activation level (e.g., a clock high level) of the first boosting clock signal may be applied to the first output control node OCN1. The output control capacitor OCC may store the clock high level applied to the first output control node OCN1.

For example, the first carry clock signal CR_CK_SC1 of the first stage may have an activation level. For example, the second carry clock signal CR_CK_SS1 of the first stage may have an activation level. In an embodiment, a length of the period in which the first input signal S1 has an activation level in the third period TP3B and a length of the period in which the first carry clock signal CR_CK_SC1 of the first stage has an activation level may be substantially the same. In an embodiment, a length of the period in which the first input signal S1 has an activation level in the third period TP3B and a length of the period in which the second carry clock signal CR_CK_SS1 of the first stage has an activation level may be substantially the same. Accordingly, a reliability of the first scan gate signal SC[1] and the first sensing gate signal SS[1] output in the sixth period TP6B may be improved.

In the fourth period TP4B, the second stage boosting clock signal BCK may have an activation level. The first gate signals SC[1] to SC[k] of the second stage may be output based on the second stage boosting clock signal BCK and the first common control signal QCS_SC of the second stage. For example, the first gate signals SC[1] to SC[k] of the second stage may be sequentially output based on the first common control signal QCS_SC of the second stage. The second gate signals SS[1] to SS[k] of the second stage may be output based on the second common control signal QCS_SS of the second stage.

In the fifth period TP5B, the second input signal S2 may have an activation level. In the fifth period TP5B, the fourth output control transistor OCT4 may be turned on in response to the second input signal S2. In the fifth period TP5B, the fifth output control transistor OCT5 may be turned on in response to the second input signal S2. Additionally, the third output control transistor OCT3 may be turned on. The third output control transistor OCT3 may be turned on, so that the output control signal OCS having the first high voltage VGH1 may be output.

In the fifth period TP5B, the fifth output transistors CT5_SC and CT5_SS may be turned on in response to the second input signal S2. The fifth output transistors CT5_SC and CT5_SS may be turned on, so that the first high voltage VGH1 may be applied to the output nodes CON1_SC and CON1_SS. Accordingly, the output control voltages OV_SC and OV_SS may have the first high voltage VGH1.

In the sixth period TP6B, the first scan clock signal SCCK[1] may be output. For example, in the sixth period TP6B, the first scan clock signal SCCK[1] may toggle between a clock high voltage and a clock low voltage. For example, in the sixth period TP6B, the first scan clock signal SCCK[1] may toggle about twice. However, the present inventive concept is not limited to a timing of the first scan clock signal SCCK[1].

In the sixth period TP6B, the first sensing clock signal SSCK[1] may be output. For example, in the sixth period TP6B, the first sensing clock signal SSCK[1] may toggle between a clock high voltage and a clock low voltage.

For example, in the blank period, the sensing operation may be performed on at least one pixel-row of the pixels of the display panel 100. For example, the at least one pixel-row may be connected to a K-th stage. The K-th stage may include a P-th scan gate line and a P-th sensing gate line. In the present embodiment, the K-th stage may perform the sensing driving. Accordingly, in the blank period, a scan gate signal and a sensing gate signal may be output to the P-th scan gate line and the P-th sensing gate line connected to the at least one pixel-row.

For example, the P-th scan gate signal applied to the P-th scan gate line of the K-th stage in the blank period may have an activation level. For example, the remaining scan gate signals excluding the P-th scan gate signal of the K-th stage in the blank period may have inactivation levels. For example, the remaining stages excluding the K-th stage in the blank period may stop outputting the scan gate signal and the sensing gate signal. For example, the P-th sensing gate signal applied to the P-th sensing gate line of the K-th stage in the blank period may have an activation level. For example, the remaining sensing gate signals excluding the P-th sensing gate signal of the K-th stage in the blank period may have inactivation levels.

Accordingly, the sensing operation may be performed on at least one pixel-row. Accordingly, when a plurality of gate signals are output based on one logic generating block (e.g., an output control signal generating block 320), the sensing operation may be performed on at least one pixel-row. The sensing operation may be performed, so that the data signal DATA based on the sensing data SD may be generated. Accordingly, a display quality of the display panel 100 may be improved.

Additionally, the stage of the gate driver to which at least one pixel is connected may operate in a blank period, and the stage of the gate driver to which at least one pixel is not connected may stop operating in the blank period, so that the power consumption of the display device 1 may be reduced.

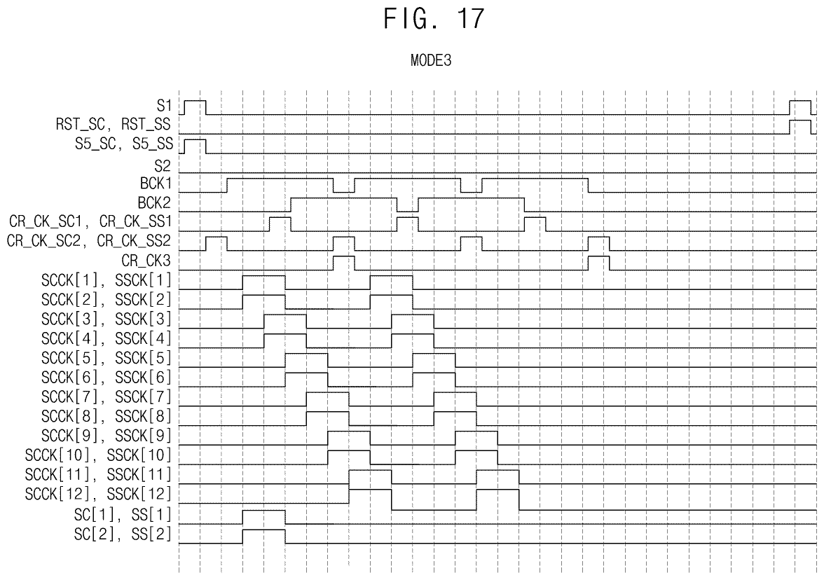

FIG. 17 is a timing diagram illustrating an example of signals applied to a gate driver 300 of FIG. 2.

A timing diagram of FIG. 17 is substantially same as the timing diagram of FIG. 4 except that an activation level period of the first scan clock signal SCCK[1] is the same as an activation level period of the second scan clock signal SCCK[2], an activation level period of the first sensing clock signal SSCK[1] is the same as an activation level period of the second sensing clock signal SSCK[2], an activation level period of the third scan clock signal SCCK[3] is the same as an activation level period of the fourth scan clock signal SCCK[4], an activation level period of the third sensing clock signal SSCK[3] is the same as an activation level period of the fourth sensing clock signal SSCK[4], an activation level period of the fifth scan clock signal SCCK[5] is the same as an activation level period of the sixth scan clock signal SCCK[6], an activation level period of the fifth sensing clock signal SSCK[5] is the same as an activation level period of the sixth sensing clock signal SSCK[6], an activation level period of the signal SCCK[7] and an activation level period of the eighth scan clock signal SCCK[8] are the same, an activation level period of the seventh sensing clock signal SSCK[7] and an activation level period of the eighth sensing clock signal SSCK[8] are the same, an activation level period of the ninth scan clock signal SCCK[9] and an activation level period of the tenth scan clock signal SCCK[10] are the same, an activation level period of the ninth sensing clock signal SSCK[9] and an activation level period of the tenth sensing clock signal SSCK[10] are the same, an activation level period of the eleventh scan clock signal SCCK[11] and an activation level period of the twelfth scan clock signal SCCK[12] are the same, an activation level period of the eleventh sensing clock signal SSCK[11] and an activation level period of the twelfth sensing clock signal SSCK[12] are the same, and a length of an activation level period of the scan gate signals and a length of an activation level period of the sensing gate signal are approximately twice a length of an activation level period of the scan gate signals of FIG. 4 and a length of an activation level period of the sensing gate signal. Accordingly, the same reference numerals will be used to refer to the same and any repetitive explanation concerning the above elements will be omitted.

Referring to FIG. 1 to FIG. 10 and FIG. 17, a driving of the gate driver 300 may be called as a third driving MODE 3. An activation level period of the first scan clock signal SCCK[1] and an activation level period of the second scan clock signal SCCK[2] are the same, an activation level period of the first sensing clock signal SSCK[1] and an activation level period of the second sensing clock signal SSCK[2] are the same, an activation level period of the third scan clock signal SCCK[3] and an activation level period of the fourth scan clock signal SCCK[4] are the same, an activation level period of the third sensing clock signal SSCK[3] and an activation level period of the fourth sensing clock signal SSCK[4] are the same, an activation level period of the fifth scan clock signal SCCK[5] and an activation level period of the sixth scan clock signal SCCK[6] are the same, an activation level period of the fifth sensing clock signal SSCK[5] and an activation level period of the sixth sensing clock signal SSCK[6] are the same, an activation level period of the seventh scan clock signal SCCK[7] and an activation level period of the eighth sensing clock signal SSCK[8] are the same, an activation level period of the ninth scan clock signal SCCK[9] and an activation level period of the tenth scan clock signal SCCK[10] are the same, an activation level period of the ninth sensing clock signal SSCK[9] and an activation level period of the tenth sensing clock signal SSCK[10] are the same, an activation level period of the eleventh scan clock signal SCCK[11] and an activation level period of the twelfth scan clock signal SCCK[12] are the same, an activation level period of the eleventh sensing clock signal SSCK[11] and an activation level period of the twelfth sensing clock signal SSCK[12] are the same, and a length of an activation level period of the scan gate signals and a length of an activation level period of the sensing gate signals may be about twice as long as the length of an activation level period of the scan gate signals of FIG. 4. For example, a period in which the first scan gate signal SC[1] has an activation level and a period in which the second scan gate signal SC[2] has an activation level may be the same. Additionally, a length of an activation period in the third driving MODE 3 may be about 0.5 times as long as the length of an activation period in the first driving MODE 1. Accordingly, a driving frequency of the display panel 100 may increase. For example, the display panel 100 may be driven at a high frequency in the third driving MODE 3. Additionally, the length of the activation level period of the scan gate signals may be about twice as long as the length of the activation level period of the sensing gate signal, so that a reliability of the gate signals applied to the pixel PX may be improved. The reliability of gate signals applied to pixels PX may be improved, an accuracy of data voltage VDATA applied to pixels PX may be improved. Accordingly, a display quality of the display panel 100 may be improved.

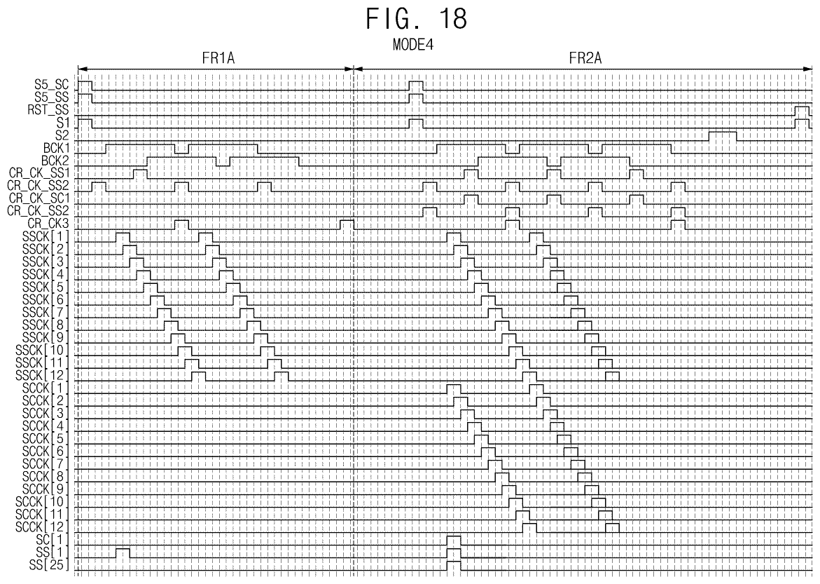

FIG. 18 is a timing diagram illustrating an example of signals applied to a gate driver 300 of FIG. 2.

Referring to FIG. 1 to FIG. 10 and FIG. 18, a frame period in which the gate driver 300 is driven may include a first frame period FR1A and a second frame period FR2A. In a first frame period FR1A, the first gate signals SC[1] to SC[k] may have an inactivation level. In a second frame period FR2A, the first gate signals SC[1] to SC[k] having an activation level may be output. For example, in the second frame period FR2A, the first gate signals SC[1] to SC[k] having an activation level may be sequentially output. For example, in the first frame period FR1A and the second frame period FR2A, the gate driver 300 may be driven in a fourth driving MODE 4. For example, the fourth driving MODE 4 may be called as variable frequency driving.

In the first frame period FR1A, the first clock signals SCCK[1], SCCK[2], SCCK[3], SCCK[4], SCCK[5], SCCK[6], SCCK[7], SCCK[8], SCCK[9], SCCK[10], SCCK[11] and SCCK[12] may be maintained as an inactivation level. Accordingly, in the first frame period FR1A, the first gate signals SC[1] to SC[k] corresponding to the first clock signals SCCK[1], SCCK[2], SCCK[3], SCCK[4], SCCK[5], SCCK[6], SCCK[7], SCCK[8], SCCK[9], SCCK[10], SCCK[11] and SCCK[12] may be maintained as an inactivation level. In the present embodiment, the first gate signals SC[1] to SC[k] may be applied to the write transistor which applies the data voltage VDATA to the pixel (PX). The first gate signals SC[1] to SC[k] may be maintained as an inactivation level in the first frame period FR1A, the data voltage VDATA may not be applied to the pixel PX. Accordingly, in the first frame period FR1A, the pixel PX may emit light based on the data voltage VDATA of the previous frame. When the third carry signal CR_CK3 has an activation level, a variable frequency driving may be stopped.

In the second frame period FR2A, the first clock signals SCCK[1], SCCK[2], SCCK[3], SCCK[4], SCCK[5], SCCK[6], SCCK[7], SCCK[8], SCCK[9], SCCK[10], SCCK[11] and SCCK[12] may have activation levels. Accordingly, in the second frame period FR2A, the first gate signals SC[1] to SC[k] corresponding to the first clock signals SCCK[1], SCCK[2], SCCK[3], SCCK[4], SCCK[5], SCCK[6], SCCK[7], SCCK[8], SCCK[9], SCCK[10], SCCK[11] and SCCK[12] may have activation levels. The first gate signals SC[1] to SC[k] may have an activation level in the second frame period FR2B, so that the data voltage VDATA may be applied to the pixel PX. Accordingly, in the second frame period FR2B, the pixel PX may emit light based on the data voltage VDATA of the current frame.

In the present embodiment, the gate driver 300 may be driven as a variable frequency driving. Accordingly, a power consumption of the display device 1 may be reduced.

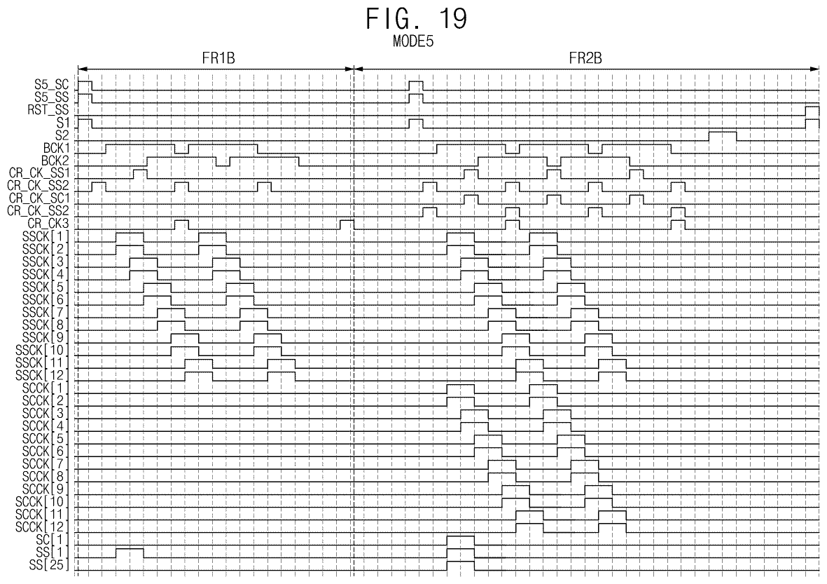

FIG. 19 is a timing diagram illustrating an example of signals applied to a gate driver 300 of FIG .2.

Referring to FIG. 1 to FIG. 10 and FIG. 19, a frame period in which the gate driver 300 is driven may include a first frame period FR1B and a second frame period FR2B. In the first frame period FR1B, the first gate signals SC[1] to SC[k] may have an inactivation level. In the second frame period FR2B, the first gate signals SC[1] to SC[k] having an activation level may be output. For example, in the second frame period FR2B, the first gate signals SC[1] to SC[k] having an activation level may be sequentially output. For example, in the first frame period FR1B and the second frame period FR2B, the gate driver 300 may be driven in a fifth driving MODE 5. For example, the fifth driving MODE 5 may be called as a variable high frequency driving.

A timing diagram of FIG. 19 is substantially same as the timing diagram of FIG. 18 except that an activation level period of the first scan clock signal SCCK[1] is the same as an activation level period of the second scan clock signal SCCK[2], an activation level period of the first sensing clock signal SSCK[1] is the same as an activation level period of the second sensing clock signal SSCK[2], an activation level period of the third scan clock signal SCCK[3] is the same as an activation level period of the fourth scan clock signal SCCK[4], an activation level period of the third sensing clock signal SSCK[3] is the same as an activation level period of the fourth sensing clock signal SSCK[4], an activation level period of the fifth scan clock signal SCCK[5] is the same as an activation level period of the sixth scan clock signal SCCK[6], an activation level period of the fifth sensing clock signal SSCK[5] is the same as an activation level period of the sixth sensing clock signal SSCK[6], an activation level period of the signal SCCK[7] and an activation level period of the eighth scan clock signal SCCK[8] are the same, an activation level period of the seventh sensing clock signal SSCK[7] and an activation level period of the eighth sensing clock signal SSCK[8] are the same, an activation level period of the ninth scan clock signal SCCK[9] and an activation level period of the tenth scan clock signal SCCK[10] are the same, an activation level period of the ninth sensing clock signal SSCK[9] and an activation level period of the tenth sensing clock signal SSCK[10] are the same, an activation level period of the eleventh scan clock signal SCCK[11] and an activation level period of the twelfth scan clock signal SCCK[12] are the same, an activation level period of the eleventh sensing clock signal SSCK[11] and an activation level period of the twelfth sensing clock signal SSCK[12] are the same, and a length of an activation level periods of the scan gate signals and a length of an activation level period of the sensing gate signals are about twice a length of an activation level period of the scan gate signals and the length of an activation level period of the sensing gate signal of FIG. 18. Accordingly, the same reference numerals will be used to refer to the same and any repetitive explanation concerning the above elements will be omitted.

The length of the activation period in the fifth driving MODE 5 may be about 0.5 times the length of the activation period in the fourth driving MODE 4. Accordingly, the driving frequency of the display panel 100 may be increased. For example, the display panel 100 may be driven at a variable high frequency in the fifth driving MODE 5. Additionally, the length of the activation level period of the scan gate signals may be about twice as long as the length of the activation level period of the sensing gate signals, so that the reliability of the gate signals applied to the pixels PX may be improved. The reliability of the gate signals applied to the pixels PX may be improved, so that the accuracy of the data voltage VDATA applied to the pixels PX may be improved. Accordingly, the display quality of the display panel 100 may be improved.

Additionally, the gate driver 300 may be driven at a variable high frequency, so that a power consumption of the display device 1 may be reduced.

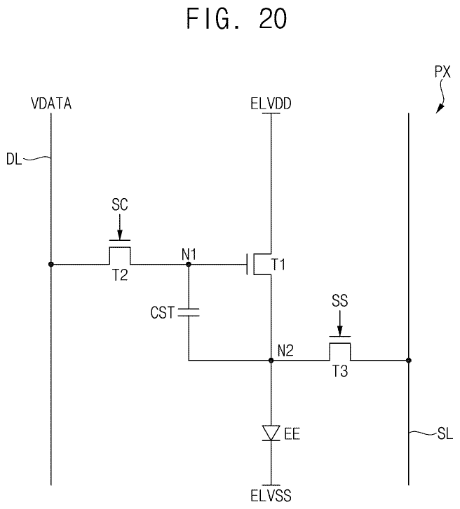

FIG. 20 is a circuit diagram illustrating an example of pixel PX of FIG. 1.

Referring to FIG. 1 and FIG. 20, the pixel PX include a first transistor T1, a second transistor T2, a third transistor T3, a storage capacitor CST and a light emitting element EE. For example, the pixel PX may have a 3T1C structure. However, the present inventive concept is not limited to a structure of the pixel PX.

The first transistor T1 may include a control electrode connected to a first node N1, a first electrode receiving a first power voltage ELVDD and a second electrode connected to a second node N2. The first transistor T1 may generate a driving current based on a voltage of the first node N1. For example, the first transistor T1 may be called as a driving transistor.

The second transistor T2 may include a control electrode receiving a scan gate signal SC, a first electrode receiving the data voltage VDATA and a second electrode connected to the first node N1. The second transistor T2 may apply the data voltage VDATA to the first node N1 in response to the scan gate signal SC. For example, the second transistor T2 may be called as a scan transistor. For example, the second transistor T2 may be called as the write transistor.

The third transistor T3 may include a control electrode receiving a sensing gate signal SS, a first electrode connected to the sensing line SL and a second electrode connected to the second node N2. The third transistor T3 may connect the sensing line SL and the second node N2 in response to the sensing gate signal SS. For example, the third transistor T3 may be called as a sensing transistor.

The storage capacitor CST may include a first electrode connected to the first node N1 and a second electrode connected to the second node N2.

The light emitting element EE may include a first electrode connected to the second node N2 and a second electrode receiving a second power voltage ELVSS. The light emitting element EE may emit light based on the driving current.

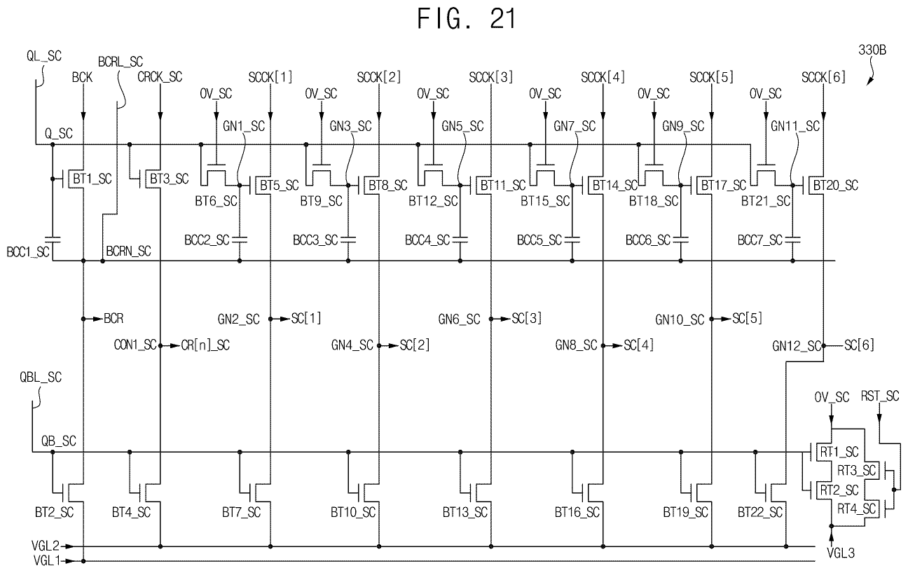

FIG. 21 is a circuit diagram illustrating an example of a first gate signal control block 330 of FIG. 3.

A first gate signal control block 330B of FIG. 21 is substantially same as the first gate signal control block 330 of FIG. 5B except that the first gate signal control block 330B further includes first to fourth reset transistors RT1_SC, RT2_SC, RT3_SC and RT4_SC. Accordingly, the same reference numerals will be used to refer to the same and any repetitive explanation concerning the above elements will be omitted.

The first gate signal control block 330B may further include the first to fourth reset transistors RT1_SC, RT2_SC, RT3_SC and RT4_SC.

The first reset transistor RT1_SC may include a control electrode connected to the first inverting common control line QBL_SC, a first electrode receiving the first output control voltage OV_SC and a second electrode connected to a first electrode of the second reset transistor RT2_SC. The second reset transistor RT2_SC may include a control electrode connected to the first inverting common control line QBL_SC, the first electrode connected to the second electrode of the first reset transistor RT1_SC and a second electrode receiving the third low voltage VGL3. The first reset transistor RT1_SC and the second reset transistor RT2_SC may be connected in series. In an embodiment, the first reset transistor RT1_SC and the second reset transistor RT2_SC may be configured as a single transistor.

The third reset transistor RT3_SC may include a control electrode receiving the first reset signal RST_SC, a first electrode receiving the first output control voltage OV_SC and a second electrode connected to a first electrode of the fourth reset transistor RT4_SC. The fourth reset transistor RT4_SC may include a control electrode receiving the first reset signal RST_SC, the first electrode connected to the second electrode of the third reset transistor RT3_SC and a second electrode receiving a third low voltage VGL3. The third reset transistor RT3_SC and the fourth reset transistor RT4_SC may be connected in series. In an embodiment, the third reset transistor RT3_SC and the fourth reset transistor RT4_SC may be configured as a single transistor.

The first gate signal control block 330B may initialize a voltage of a line receiving the first output control voltage OV_SC through the first to fourth reset transistors RT1_SC, RT2_SC, RT3_SC and RT4_SC. For example, the line receiving the first output control voltage OV_SC may be initialized to the third low voltage VGL3.

FIG. 22 is a circuit diagram illustrating an example of a second gate signal control block 350 of FIG. 3.

A second gate signal control block 350B of FIG. 22 is substantially same as the second gate signal control block 350 of FIG. 5D except that the first gate signal control block 330B further includes first to fourth reset transistors RT1_SS, RT2_SS, RT3_SS and RT4_SS. Accordingly, the same reference numerals will be used to refer to the same and any repetitive explanation concerning the above elements will be omitted.

The second gate signal control block 350B may further include the first to fourth reset transistors RT1_SS, RT2_SS, RT3_SS and RT4_SS.

The first reset transistor RT1_SS may include a control electrode connected to the second inverting common control line QBL_SS, a first electrode receiving the second output control voltage OV_SS and a second electrode connected to a first electrode of the second reset transistor RT2_SS. The second reset transistor RT2_SS may include a control electrode connected to the second inverting common control line QBL_SS, a first electrode connected to the second electrode of the first reset transistor RT1_SS and a second electrode receiving the third low voltage VGL3. The first reset transistor RT1_SS and the second reset transistor RT2_SS may be connected in series. In an embodiment, the first reset transistor RT1_SS and the second reset transistor RT2_SS may be configured as a single transistor.

The third reset transistor RT3_SS may include a control electrode receiving the second reset signal RST_SS, a first electrode receiving the second output control voltage OV_SS and a second electrode connected to the first electrode of the fourth reset transistor RT4_SS. The fourth reset transistor RT4_SS may include a control electrode receiving the second reset signal RST_SS, a first electrode connected to the second electrode of the third reset transistor RT3_SS and a second electrode receiving the third low voltage VGL3. The third reset transistor RT3_SS and the fourth reset transistor RT4_SS may be connected in series. In an embodiment, the third reset transistor RT3_SS and the fourth reset transistor RT4_SS may be configured as a single transistor.

The second gate signal control block 350B may initialize a voltage of a line receiving the second output control voltage OV_SS through the first to fourth reset transistors RT1_SS, RT2_SS, RT3_SS and RT4_SS. For example, the line receiving the second output control voltage OV_SS may be initialized to the third low voltage VGL3.

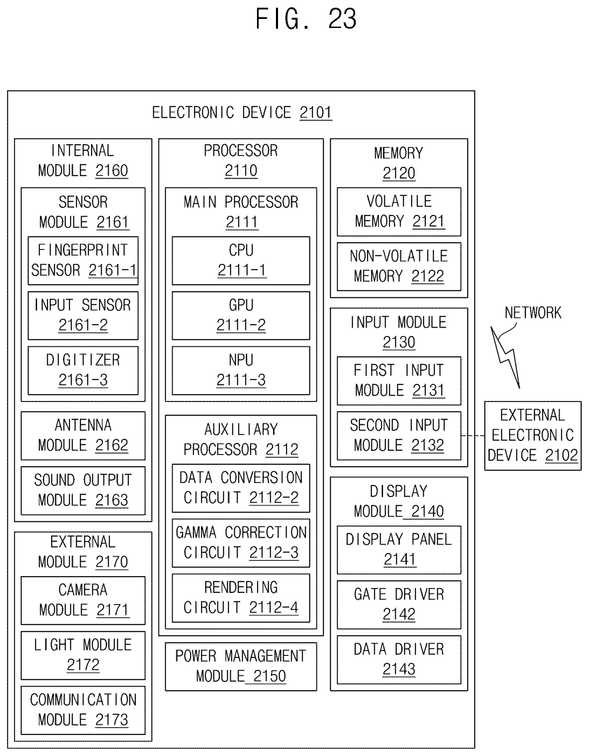

FIG. 23 is a block diagram illustrating an electronic device 2101 according to an embodiment 2101.

Referring to FIG. 1 to FIG. 23, the electronic device 2101 may output various information via a display module 2140 in an operating system. When a processor 2110 executes an application stored in a memory 2120, the display module 2140 may provide application information to a user via a display panel 2141. For example, the display module 2140 may mean the display device 1. For example, the processor 2110 may mean a controller. For example, the processor 2110 may output the input image data IMG and the input control signal CONT to the driving controller 200. In an embodiment, the processor 2110 may select the first to fifth driving MODE 1, MODE 2, MODE 3, MODE 4 and MODE 5. The input control signal CONT may include information including the first to fifth driving MODE 1, MODE 2, MODE 3, MODE 4 and MODE 5.

The processor 2110 may obtain an external input via an input module 2130 or a sensor module 2161 and may execute an application corresponding to the external input. For example, when the user selects a camera icon displayed on the display panel 2141, the processor 2110 may obtain a user input via an input sensor 2161-2 and may activate a camera module 2171. The processor 2110 may transfer image data corresponding to an image captured by the camera module 2171 to the display module 2140. The display module 2140 may display an image corresponding to the captured image via the display panel 2141.

As another example, when personal information authentication is executed in the display module 2140, a fingerprint sensor 2161-1 may obtain input fingerprint information as input data. The processor 2110 may compare the input data obtained by the fingerprint sensor 2161-1 with authentication data stored in the memory 2120, and may execute an application according to the comparison result. The display module 2140 may display information executed according to application logic via the display panel 2141.

As another example, when a music streaming icon displayed on the display module 2140 is selected, the processor 2110 obtains a user input via the input sensor 2161-2 and may activate a music streaming application stored in the memory 2120. When a music execution command is input in the music streaming application, the processor 2110 may activate a sound output module 2163 to provide sound information corresponding to the music execution command to the user.

In the above, an operation of the electronic device 2101 has been briefly described. Hereinafter, a configuration of the electronic device 2101 will be described in detail. Some components of the electronic device 2101 described below may be integrated and provided as one component or one component may be provided separately as two or more components.

The electronic device 2101 may communicate with an external electronic device 2102 via a network (e.g., a short-range wireless communication network or a long-range wireless communication network). In an embodiment, the electronic device 2101 may include the processor 2110, the memory 2120, the input module 2130, the display module 2140, a power management module 2150, an internal module 2160 and an external module 2170. In an embodiment, at least one of the components may be omitted from the electronic device 2101 or one or more other components may be added in the electronic device 2101. In an embodiment, some of the components (e.g., the sensor module 2161, an antenna module 2162 or the sound output module 2163) may be implemented as a single component (e.g., the display module 2140).

The processor 2110 may execute software to control at least one other component (e.g., a hardware or software component) of the electronic device 2101 coupled with the processor 2110 and may perform various data processing or computation. According to an embodiment, as at least part of the data processing or computation, the processor 2110 may store a command or data received from another component (e.g., the input module 2130, the sensor module 2161 or a communication module 2173) in volatile memory 2121, may process the command or the data stored in the volatile memory 2121and may store resulting data in non-volatile memory 2122.

The processor 2110 may include one or more processors and may include a main processor 2111 and an auxiliary processor 2112. The main processor 2111 may include one or more of a central processing unit (CPU) 2111-1 or an application processor (AP). The main processor 2111 may further include any one or more of a graphics processing unit (GPU) 2111-2, a communication processor (CP) and an image signal processor (ISP). The main processor 2111 may further include a neural processing unit (NPU) 2111-3. The NPU 2111-3 may be a processor specialized in processing an artificial intelligence model and the artificial intelligence model may be generated through machine learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof, but is not limited thereto. The artificial intelligence model may, additionally or alternatively, include a software structure other than a hardware structure. At least two of the above-described processing units and processors may be implemented as an integrated component (e.g., a single chip) or respective processing units and processors may be implemented as independent components (e.g., a plurality of chips).

The auxiliary processor 2112 may include a controller. The controller may include an interface conversion circuit and a timing control circuit. The controller may receive an image signal from the main processor 2111, may convert a data format of the image signal to meet interface specifications with the display module 2140 and may output image data. The controller may output various control signals required for driving the display module 2140.

The auxiliary processor 2112 may further include a data conversion circuit 2112-2, a gamma correction circuit 2112-3, a rendering circuit 2112-4 or the like. The data conversion circuit 2112-2 may receive image data from the controller. The data conversion circuit 2112-2 may compensate for the image data such that an image is displayed with a desired luminance according to characteristics of the electronic device 2101 or the user's setting or may convert the image data to reduce power consumption or to eliminate an afterimage. The gamma correction circuit 2112-3 may convert image data or a gamma reference voltage so that an image displayed on the electronic device 2101 has desired gamma characteristics. The rendering circuit 2112-4 may receive image data from the controller and may render the image data in consideration of a pixel arrangement of the display panel 2141 in the electronic device 2101. At least one of the data conversion circuit 2112-2, the gamma correction circuit 2112-3 and the rendering circuit 2112-4 may be integrated in another component (e.g., the main processor 2111 or the controller). At least one of the data conversion circuit 2112-2, the gamma correction circuit 2112-3 and the rendering circuit 2112-4 may be integrated in a data driver 2143 described below.

The memory 2120 may store various data used by at least one component (e.g., the processor 2110 or the sensor module 2161) of the electronic device 2101. The various data may include, for example, input data or output data for a command related thereto. The memory 2120 may include at least one of the volatile memory 2121 and the non-volatile memory 2122.

The input module 2130 may receive a command or data to be used by the components (e.g., the processor 2110, the sensor module 2161 or the sound output module 2163) of the electronic device 2101 from the outside of the electronic device 2101 (e.g., the user or the external electronic device 2102).

The input module 2130 may include a first input module 2131 for receiving a command or data from the user and a second input module 2132 for receiving a command or data from the external electronic device 2102. The first input module 2131 may include a microphone, a mouse, a keyboard, a key (e.g., a button) or a pen (e.g., a passive pen or an active pen). The second input module 2132 may support a designated protocol capable of connecting the electronic device 2101 to the external electronic device 2102 by wire or wirelessly. In an embodiment, the second input module 2132 may include a high definition multimedia interface (HDMI), a universal serial bus (USB) interface, an SD card interface or an audio interface. The second input module 2132 may include a connector that may physically connect the electronic device 2101 to the external electronic device 2102. For example, the second input module 2132 may include an HDMI connector, a USB connector, an SD card connector or an audio connector (e.g., a headphone connector).

The display module 2140 may visually provide information to the user. The display module 2140 may include the display panel 2141, a gate driver 2142 and the data driver 2143. The display module 2140 may further include a window, a chassis and a bracket for protecting the display panel 2141.

The display panel 2141 may include a liquid crystal display panel, an organic light emitting display panel or an inorganic light emitting display panel, but the type of the display panel 2141 is limited thereto. The display panel 2141 may be a rigid type display panel or a flexible type display panel capable of being rolled or folded. The display module 2140 may further include a supporter, a bracket or a heat dissipation member that supports the display panel 2141.

The gate driver 2142 may be mounted on the display panel 2141 as a driving chip. In an embodiment, the gate driver 2142 may be integrated into the display panel 2141. For example, the gate driver 2142 may include an amorphous silicon TFT gate driver circuit (ASG), a low temperature polycrystalline silicon (LTPS) TFT gate driver circuit or an oxide semiconductor TFT gate driver circuit (OSG) embedded in the display panel 2141. The gate driver 2142 may receive a control signal from the controller and may output scan signals to the display panel 2141 in response to the control signal. For example, the gate driver 300 may include a stage that generates the common control signal and outputs a plurality of gate signals based on the common control signal. The gate driver 2142 may be driven by any one of the first to fifth driving MODE 1, MODE 2, MODE 3, MODE 4 and MODE 5 based on the input control signal CONT. For example, when the processor 2110 selects the first driving MODE 1, the gate driver 2142 may be driven at the timing of the first driving MODE 1 (e.g., the timing of FIG. 4). For example, when the processor 2110 selects the second driving MODE 2, the gate driver 2142 may be driven at the timing of the second driving MODE 2 (e.g., the timing of FIG. 8). For example, when the processor 2110 selects the third driving MODE 3, the gate driver 2142 may be driven at the timing of the third driving MODE 3 (e.g., the timing of FIG. 17). For example, when the processor 2110 selects the fourth driving MODE 4, the gate driver 2142 may be driven at the timing of the fourth driving MODE 4 (e.g., the timing of FIG. 18). For example, when the processor 2110 selects the fifth driving MODE 5, the gate driver 2142 may be driven at the timing of the fifth driving MODE 5 (e.g., the timing of FIG. 19).

The display panel 2141 may further include an emission driver. The emission driver may output an emission control signal to the display panel 2141 in response to a control signal received from the controller. The emission driver may be formed separately from the gate driver 2142 or may be integrated into the gate driver 2142.

The data driver 2143 may receive a control signal from the controller, may convert image data into analog voltages (e.g., data voltages) in response to the control signal and then may output the data voltages to the display panel 2141.

The data driver 2143 may be incorporated into other components (e.g., the controller). Further, the functions of the interface conversion circuit and the timing control circuit of the controller described above may be integrated into the data driver 2143.

The display module 2140 may further include the emission driver, a voltage generator circuit or the like. The voltage generator circuit may output various voltages used to drive the display panel 2141.

The power management module 2150 may supply power to the components of the electronic device 2101. The power management module 2150 may include a battery that charges a power supply voltage. The battery may include a primary cell which is not rechargeable, a secondary cell which is rechargeable or a fuel cell. The power management module 2150 may include a power management integrated circuit (PMIC). The PMIC may supply optimal power to each of the modules described above and modules described below. The power management module 2150 may include a wireless power transmission/reception member electrically connected to the battery. The wireless power transmission/reception member may include a plurality of antenna radiators in the form of coils.

The electronic device 2101 may further include the internal module 2160 and the external module 2170. The internal module 2160 may include the sensor module 2161, the antenna module 2162 and the sound output module 2163. The external module 2170 may include the camera module 2171, a light module 2172 and the communication module 2173.

The sensor module 2161 may detect an input by the user's body or an input by the pen of the first input module 2131 and may generate an electrical signal or data value corresponding to the input. The sensor module 2161 may include at least one of the fingerprint sensor 2161-1, the input sensor 2161-2 and a digitizer 2161-3.

The fingerprint sensor 2161-1 may generate a data value corresponding to the user's fingerprint. The fingerprint sensor 2161-1 may include any one of an optical type fingerprint sensor and a capacitive type fingerprint sensor.

The input sensor 2161-2 may generate a data value corresponding to coordinate information of the user's body input or the pen input. The input sensor 2161-2 may convert a capacitance change caused by the input into the data value. The input sensor 2161-2 may detect the input by the passive pen or may transmit/receive data to/from the active pen.

The input sensor 2161-2 may measure a bio-signal, such as blood pressure, moisture or body fat. For example, when a portion of the body of the user touches a sensor layer or a sensing panel and does not move for a certain period of time, the input sensor 2161-2 may output information desired by the user to the display module 2140 by detecting the bio-signal based on a change in electric field due to the portion of the body.

The digitizer 2161-3 may generate a data value corresponding to coordinate information of the input by the pen. The digitizer 2161-3 may convert an amount of an electromagnetic change caused by the input into the data value. The digitizer 2161-3 may detect the input by the passive pen or may transmit/receive data to/from the active pen.

At least one of the fingerprint sensor 2161-1, the input sensor 2161-2 and the digitizer 2161-3 may be implemented as a sensor layer formed on the display panel 2141 through a continuous process. The fingerprint sensor 2161-1, the input sensor 2161-2 and the digitizer 2161-3 may be disposed above the display panel 2141 or at least one of the fingerprint sensor 2161-1, the input sensor 2161-2 and the digitizer 2161-3 may be disposed below the display panel 2141.

Two or more of the fingerprint sensor 2161-1, the input sensor 2161-2 and the digitizer 2161-3 may be integrated into one sensing panel through the same process. When integrated into one sensing panel, the sensing panel may be disposed between the display panel 2141 and a window disposed above the display panel 2141. In an embodiment, the sensing panel may be disposed on the window, but the location of the sensing panel is not limited thereto.

At least one of the fingerprint sensor 2161-1, the input sensor 2161-2 and the digitizer 2161-3 may be embedded in the display panel 2141. In other words, at least one of the fingerprint sensor 2161-1, the input sensor 2161-2 and the digitizer 2161-2 may be simultaneously formed through a process of forming elements (e.g., light emitting elements, transistors, etc.) included in the display panel 2141.

In addition, the sensor module 2161 may generate an electrical signal or a data value corresponding to an internal state or an external state of the electronic device 2101. The sensor module 2161 may further include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor or an illuminance sensor.

The antenna module 2162 may include one or more antennas for transmitting or receiving a signal or power to or from the outside. In an embodiment, the communication module 2173 may transmit or receive a signal to or from the external electronic device 2102 through an antenna suitable for a communication method. An antenna pattern of the antenna module 2162 may be integrated into one component (e.g., the display panel 2141) of the display module 2140 or the input sensor 2161-2.

The sound output module 2163 may output sound signals to the outside of the electronic device 2101. The sound output module 2163 may include, for example, a speaker or a receiver. The speaker may be used for general purposes, such as playing multimedia or playing record. The receiver may be used for receiving incoming calls. In an embodiment, the receiver may be implemented as separate from or as part of the speaker. A sound output pattern of the sound output module 2163 may be integrated into the display module 2140.

The camera module 2171 may capture a still image and a moving image. In an embodiment, the camera module 2171 may include one or more lenses, an image sensor or an image signal processor. The camera module 2171 may further include an infrared camera capable of measuring the presence or absence of the user, the user's location and the user's line of sight.

The light module 2172 may provide light. The light module 2172 may include a light emitting diode or a xenon lamp. The light module 2172 may operate in conjunction with the camera module 2171 or may operate independently of the camera module 2171.

The communication module 2173 may support establishing a wired or wireless communication channel between the electronic device 2101 and the external electronic device 2102 and performing communication via the established communication channel. The communication module 2173 may include a wireless communication module (e.g., a cellular communication module, a short-range wireless communication module or a global navigation satellite system (GNSS) communication module) or a wired communication module (e.g., a local area network (LAN) communication module or a power line communication (PLC) module). The communication module 2173 may communicate with the external electronic device 2102 via a short-range communication network (e.g., Bluetooth™, wireless-fidelity (Wi-Fi) direct or infrared data association (IrDA)) or a long-range communication network (e.g., a cellular network, the Internet or a computer network (e.g., LAN or wide area network (WAN)). These various types of communication modules 2173 may be implemented as a single chip or may be implemented as multi-chips separate from each other.

The input module 2130, the sensor module 2161, the camera module 2171 and the like may be used to control an operation of the display module 2140 in conjunction with the processor 2110.

The processor 2110 may output a command or data to the display module 2140, the sound output module 2163, the camera module 2171 or the light module 2172 based on input data received from the input module 2130. For example, the processor 2110 may generate image data corresponding to input data applied through a mouse or an active pen and may output the image data to the display module 2140. In an embodiment, the processor 2110 may generate command data corresponding to the input data and may output the command data to the camera module 2171 or the light module 2172. When no input data is received from the input module 2130 for a certain period of time, the processor 2110 may switch an operation mode of the electronic device 2101 to a low power mode or a sleep mode, thereby reducing power consumption of the electronic device 2101.

The processor 2110 may output a command or data to the display module 2140, the sound output module 2163, the camera module 2171 or the light module 2172 based on sensing data received from the sensor module 2161. For example, the processor 2110 may compare authentication data applied by the fingerprint sensor 2161-1 with authentication data stored in the memory 2120 and then may execute an application according to the comparison result. The processor 2110 may execute a command or output corresponding image data to the display module 2140 based on the sensing data sensed by the input sensor 2161-2 or the digitizer 2161-3. In a case where the sensor module 2161 includes a temperature sensor, the processor 2110 may receive temperature data from the sensor module 2161 and may further perform luminance correction on the image data based on the temperature data.

The processor 2110 may receive measurement data about the presence or absence of the user, the location of the user and the user's line of sight from the camera module 2171. The processor 2110 may further perform luminance correction on the image data based on the measurement data. For example, after the processor 2110 determines the presence or absence of the user based on the input from the camera module 2171, the data conversion circuit 2112-2 or the gamma correction circuit 2112-3 may perform the luminance correction on the image data and the processor 2110 may provide the luminance-corrected image data to the display module 2140.

At least some of the above-described components may be coupled mutually and communicate signals (e.g., commands or data) therebetween via an inter-peripheral communication scheme (e.g., a bus, general purpose input and output (GPIO), serial peripheral interface (SPI), mobile industry processor interface (MIPI) or ultra-path interconnect (UPI)). The processor 2110 may communicate with the display module 2140 via an agreed interface. Further, any one of the above-described communication methods may be used between the processor 2110 and the display module 2140, but the communication method between the processor 2110 and the display module 2140 is not limited to the above-described communication method.

The electronic device 2101 according to various embodiments described above may be various types of devices. For example, the electronic device 2101 may include at least one of a portable communication device (e.g., a smart phone), a computer device, a portable multimedia device, a portable medical device, a camera, a wearable device and a home appliance. However, the electronic device 2101 according to embodiments is not limited to the above-described devices.

The display device according to the embodiments may be applied to a display apparatus included in a computer, a notebook, a mobile phone, a smart phone, a smart pad, a PMP, a PDA, an MP3 player, or the like.

The foregoing is illustrative of the present inventive concept and is not to be construed as limiting thereof. Although a few embodiments of the present inventive concept have been described, those skilled in the art will readily appreciate that many modifications are possible in the embodiments without materially departing from the novel teachings and advantages of the present inventive concept. Accordingly, all such modifications are intended to be included within the scope of the present inventive concept as defined in the claims. In the claims, means-plus-function clauses are intended to cover the structures described herein as performing the recited function and not only structural equivalents but also equivalent structures. Therefore, it is to be understood that the foregoing is illustrative of the present inventive concept and is not to be construed as limited to the specific embodiments disclosed, and that modifications to the disclosed embodiments, as well as other embodiments, are intended to be included within the scope of the appended claims. The present inventive concept is defined by the following claims, with equivalents of the claims to be included therein.

What is claimed is:

1. A gate driver comprising:
a control signal generating block configured to generate a first common control signal based on a first carry signal and a second carry signal and generate a second common control signal based on a third carry signal and a fourth carry signal;
an output control signal generating block configured to generate an output control signal based on a first input signal, a second input signal and a boosting control signal;
a first gate signal output control block configured to generate a first output control voltage based on the output control signal, the first carry signal and the second carry signal;
a first gate signal control block configured to output first gate signals and the boosting control signal based on the first common control signal, the first output control voltage, a boosting clock signal and first clock signals;
a second gate signal output control block configured to generate a second output control voltage based on the output control signal, the third carry signal and the fourth carry signal; and
a second gate signal control block configured to output second gate signals based on the second common control signal, the second output control voltage, the boosting clock signal and second clock signals.

2. The gate driver of claim 1, wherein the output control signal generating block includes:
a first output control transistor including a control electrode receiving the first input signal, a first electrode receiving the boosting control signal and a second electrode connected to a first output control node;
a second output control transistor including a control electrode receiving the first input signal, a first electrode connected to the first output control node and a second electrode connected to a second output control node;
a third output control transistor including a control electrode connected to the second output control node and a second electrode connected to the first output control node;
a fourth output control transistor including a control electrode receiving the second input signal, a first electrode connected to the first output control node and a second electrode connected to a first common control node; and
an output control capacitor including a first electrode receiving a first high voltage and a second electrode connected to the second output control node.

3. The gate driver of claim 1, wherein when the first input signal has an activation level, and the boosting clock signal has a clock high level, the output control signal generating block stores the output control signal.

4. The gate driver of claim 3, wherein when the second input signal has an activation level, the output control signal generating block outputs the output control signal.

5. The gate driver of claim 3, wherein the first gate signal control block further outputs a carry signal based on a carry clock signal, and
wherein when the first input signal has an activation level, the carry clock signal has a clock high level.

6. The gate driver of claim 1, wherein a frame period in which the gate driver is driven includes an active period in which the first gate signals are output and a blank period following the active period,
wherein in the blank period, a first gate signal of the first gate signals has an activation level, and
wherein in the blank period, a second gate signal of the second gate signals has an activation level.

7. The gate driver of claim 6, wherein in the blank period, the first output control voltage has a first high voltage, and a first clock signal corresponding to the first gate signal toggles between a clock high level and a clock low level.

8. The gate driver of claim 7, wherein in the blank period, other first gate signals of the first gate signals have an inactivation level, and
wherein in the blank period, other second gate signals of the second gate signals have an inactivation level.

9. The gate driver of claim 1, wherein the first output control voltage has a first high voltage or a second high voltage lower than the first high voltage,
wherein the second output control voltage has the first high voltage or the second high voltage,
wherein when the first output control voltage has the first high voltage, the first gate signals are output, and
wherein when the second output control voltage has the first high voltage, the second gate signals are output.

10. The gate driver of claim 1, wherein the first gate signals include a first scan gate signal and a second scan gate signal,
wherein a frame period in which the gate driver is driven includes an active period in which first gate signals are output and a blank period following the active period, and
wherein a period in which the first scan gate signal has an activation level is consistent with a period in which the second scan gate signal has an activation level.

11. A display device comprising:
a display panel including a plurality of pixels;
a gate driver configured to output gate signals to the pixels;
a data driver configured to apply data voltage to the pixels; and
a driving controller configured to control the gate driver and the data driver,
wherein the gate driver includes a plurality of stages,
wherein at least one stage of the stages includes:
a control signal generating block configured to generate a first common control signal based on a first carry signal and a second carry signal and generate a second common control signal based on a third carry signal and a fourth carry signal;
an output control signal generating block configured to generate an output control signal based on a first input signal, a second input signal and a boosting control signal;
a first gate signal output control block configured to generate a first output control voltage based on the output control signal, the first carry signal and the second carry signal;
a first gate signal control block configured to output first gate signals and the boosting control signal based on the first common control signal, the first output control voltage, a boosting clock signal and first clock signals;
a second gate signal output control block configured to generate a second output control voltage based on the output control signal, the third carry signal and the fourth carry signal; and
a second gate signal control block configured to output second gate signals based on the second common control signal, the second output control voltage, the boosting clock signal and second clock signals.

12. The display device of claim 11, wherein the output control signal generating block includes:
a first output control transistor including a control electrode receiving the first input signal, a first electrode receiving the boosting control signal and a second electrode connected to a first output control node;
a second output control transistor including a control electrode receiving the first input signal, a first electrode connected to the first output control node and a second electrode connected to a second output control node;
a third output control transistor including a control electrode connected to the second output control node and a second electrode connected to the first output control node;
a fourth output control transistor including a control electrode receiving the second input signal, a first electrode connected to the first output control node and a second electrode connected to a first common control node; and
an output control capacitor including a first electrode receiving a first high voltage and a second electrode connected to the second output control node.

13. The display device of claim 11, wherein the gate driver includes a first stage and a second stage,
wherein the first gate signals include first, second, third, and fourth scan gate signals and first, second, third, and fourth sensing gate signals,
wherein the first stage outputs the first scan gate signal, the second scan gate signal, the first sensing gate signal and the second sensing gate signal, and
wherein the second stage outputs the third scan gate signal, the fourth scan gate signal, the third sensing gate signal and the fourth sensing gate signal.

14. The display device of claim 13, further comprising a sensing driver configured to perform a sensing operation on at least one pixel of the pixels,
wherein a frame period in which the pixels are driven includes an active period in which the data voltage is applied and a blank period in which the sensing operation is performed on the at least one pixel, and
wherein when the at least one pixel is connected to the first stage, the first output control voltage of the first stage has a first high voltage in the blank period.

15. The display device of claim 14, wherein in the blank period, the scan gate signal applied to the at least one pixel has an activation level.

16. The display device of claim 13, further comprising a sensing driver configured to perform a sensing operation on at least one pixel of the pixels,
wherein a frame period in which the pixels are driven includes an active period in which the data voltage is applied and a blank period in which the sensing operation is performed on the at least one pixel, and
wherein when the at least one pixel is connected to the first stage, the first output control voltage of the first stage and the second output control voltage of the first stage have a first high voltage in the blank period, and
wherein in the blank period, the scan gate signal applied to the at least one pixel has an activation level, and the sensing gate signal applied to the at least one pixel has an activation level.

17. The display device of claim 11, further comprising a sensing driver connected to the pixels through sensing lines,
wherein at least one pixel of the pixels includes:
a driving transistor including a control electrode connected to a first node, a first electrode receiving a first power voltage and a second electrode connected to a second node;
a scan transistor configured to apply the data voltage to the first node in response to a scan gate signal;
a sensing transistor configured to connect the sensing line and the second node in response to a sensing gate signal; and
a light emitting element including a first electrode connected to the second node and a second electrode receiving a second power voltage, and
wherein the scan gate signal is the first gate signal, and a sensing gate signal is the second gate signal.

18. An electronic device comprising:
a controller configured to output input image data and an input control signal;
a display panel configured to display an image based on the input image data; and
a panel driver configured to drive the display panel based on the input image data and the input control signal,
wherein the display panel includes a plurality of pixels,
wherein the panel driver includes a gate driver configured to output first gate signals and second gate signals to the pixels,
a control signal generating block configured to generate a first common control signal based on a first carry signal and a second carry signal and generate a second common control signal based on a third carry signal and a fourth carry signal;
an output control signal generating block configured to generate an output control signal based on a first input signal, a second input signal and a boosting control signal;
a first gate signal output control block configured to generate a first output control voltage based on the output control signal, the first carry signal and the second carry signal;
a first gate signal control block configured to output the first gate signals and the boosting control signal based on the first common control signal, the first output control voltage, a boosting clock signal and first clock signals;
a second gate signal output control block configured to generate a second output control voltage based on the output control signal, the third carry signal and the fourth carry signal; and
a second gate signal control block configured to output the second gate signals based on the second common control signal, the second output control voltage, the boosting clock signal and second clock signals, and
wherein the input control signal includes data selecting a driving mode of the display panel.

19. The electronic device of claim 18, wherein when the input control signal includes data of the sensing driving, the first input signal has an activation level, the boosting lock signal has a clock high level, and the output control signal generating block stores the output control signal.

20. The electronic device of claim 19, wherein when the input control signal includes data of the sensing driving, the second input signal has an activation level, and the output control signal generating block outputs the output control signal.
